(19) United States
(12) Patent Application Publication
(10) Pub. No.: US 2026/0024088 A1
(43) Pub. Date: Jan. 22, 2026

(54) BIFURCATING AN EVENT TO PREVENT AN ADVERSE ACTION

(71) Applicant: The Toronto-Dominion Bank, Toronto (CA)

(72) Inventor: Ruchira Ghosh, Dallas, TX (US)

(73) Assignee: The Toronto-Dominion Bank, Toronto (CA)

(21) Appl. No.: 18/776,840

(22) Filed: Jul. 18, 2024

(51) Int. Cl. G06Q 20/40

(52) U.S. Cl. CPC G06Q 20/4016

(57) ABSTRACT

An example operation may include one or more of implementing a trained artificial intelligence (AI) model using a neural network training capability with at least one of activity risk attributes, activity risk patterns of behavior, and model feedback data, receiving a request to execute an event comprising a first event attribute and a predefined event path through a processing network, obtaining previous event content associated with the event from a database, executing an AI model on the first event attribute and the previous event content to predict an event risk level, generating a different event which includes a second event attribute than the first event attribute of the event based on the event risk level, and outputting a default automated action of the different event.

### BACKGROUND

When a user of a profile performs an action through a valid profile, and the action is deemed to be a potential occurrence of fraud, the profile is typically suspended by the institution. However, in many cases, the user is not attempting to commit fraud, however, some aspect of the action may appear abnormal such as context associated with the user and/or an event being attempted by the user, a type of the event, behavior of the user during the event process, and the like. In these cases, the user is unnecessarily penalized by the suspension. In many cases, the user must place a call to the institution to have the suspension lifted which can be a significant inconvenience to the user while also causing extra work by the institution to perform the lifting of the suspension.

### SUMMARY

One example embodiment provides an apparatus that includes a memory communicably coupled to a processor, wherein the processor may one or more of implement a trained artificial intelligence (AI) model through a use of a neural network training capability with at least one of activity risk attributes, activity risk patterns of behavior, and model feedback data, receive a request to execute an event comprising a first event attribute and a predefined event path through a processing network, obtain previous event content associated with the event from a database, execute an AI model on the first event attribute and the previous event content to predict an event risk level, generate a different event which includes a second event attribute than the first event attribute of the event based on the event risk level, and output a default automated action of the different event.

Another example embodiment provides a method that includes one or more of implementing a trained artificial intelligence (AI) model using a neural network training capability with at least one of activity risk attributes, activity risk patterns of behavior, and model feedback data, receiving a request to execute an event comprising a first event attribute and a predefined event path through a processing network, obtaining previous event content associated with the event from a database, executing an AI model on the first event attribute and the previous event content to predict an event risk level, generating a different event which includes a second event attribute than the first event attribute of the event based on the event risk level, and outputting a default automated action of the different event.

A further example embodiment provides a computer readable storage medium comprising instructions, that when read by a processor, cause the processor to perform one or more of implementing a trained artificial intelligence (AI) model using a neural network training capability with at least one of activity risk attributes, activity risk patterns of behavior, and model feedback data, receiving a request to execute an event comprising a first event attribute and a predefined event path through a processing network, obtaining previous event content associated with the event from a database, executing an AI model on the first event attribute and the previous event content to predict an event risk level, generating a different event which includes a second event attribute than the first event attribute of the event based on the event risk level, and outputting a default automated action of the different event.

One example embodiment provides an apparatus that includes a memory communicably coupled to a processor, wherein the processor may one or more of receive conversation content from an ongoing communication session with a computing device associated with a profile, obtain previous conversation content of the profile from a database, implement a trained artificial intelligence (AI) model including a neural network capability to match the conversation content to the groups of conditions within the table, execute the trained AI model on the conversation content and the previous conversation content to determine content that matches a group of conditions within the table, and present a parameter that is mapped to the group of conditions within the table via a graphical user interface (GUI) of the computing device at a point in time during the ongoing communication session.

Another example embodiment provides a method that includes one or more of receiving conversation content from an ongoing communication session with a computing device associated with a profile, obtaining previous conversation content of the profile from a database, implementing a trained artificial intelligence (AI) model including a neural network capability to match the conversation content to the groups of conditions within a table, executing the trained AI model on the conversation content and the previous conversation content to determine content that matches a group of conditions within the table, and presenting a parameter that is mapped to the group of conditions within the table via a graphical user interface (GUI) of the computing device at a point in time during the ongoing communication session.

A further example embodiment provides a computer readable storage medium comprising instructions, that when read by a processor, cause the processor to perform one or more of receiving conversation content from an ongoing communication session with a computing device associated with a profile, obtaining previous conversation content of the profile from a database, implementing a trained artificial intelligence (AI) model including a neural network capability to match the conversation content to the groups of conditions within a table, executing the trained AI model on the conversation content and the previous conversation content to determine content that matches a group of conditions within the table, and presenting a parameter that is mapped to the group of conditions within the table via a graphical user interface (GUI) of the computing device at a point in time during the ongoing communication session.

### BRIEF DESCRIPTION OF DRAWINGS

FIG. 1 is a system diagram illustrating an operating environment of a software service according to examples and features of the instant solution.

FIG. 2A is a system diagram illustrating integration of an AI model into any decision point according to the examples and features of the instant solution.

FIG. 2B is a diagram illustrating a process for developing an AI model that supports AI-assisted computer decision points according to the examples and features of the instant solution.

FIG. 2C is a diagram illustrating a process for utilizing an AI model that supports AI-assisted computer decision points according to examples and features of the instant solution.

FIG. 3 is a system diagram illustrating an operating environment for a modification service, according to examples and features of the instant solution.

FIGS. 4A-4C are diagrams illustrating a process of generating a different transaction with a different transaction path according to examples and features of the instant solution.

FIG. 5A is a diagram illustrating a process of queuing an originally requested transaction according to examples and features of the instant solution.

FIG. 5B is a diagram illustrating a process of providing an additional transaction based on the originally requested transaction according to examples and features of the instant solution.

FIGS. 6A-6B are diagrams illustrating examples of transaction authorization messages with modified content according to examples and features of the instant solution.

FIGS. 7A-7C are diagrams illustrating a process of dynamically offering an object to a caller during a communication session according to examples and features of the instant solution.

FIGS. 8A-8C are diagrams illustrating a process of offering an object to a profile at a subsequent point in time according to examples and features of the instant solution.

FIG. 9 is a diagram illustrating a process of removing content from a future correspondence based on communication content during an ongoing communication session according to examples and features of the instant solution.

FIG. 10A is a diagram illustrating a method of generating a different transaction based on a fraud indicator according to examples and features of the instant solution.

FIG. 10B is a diagram illustrating a method of dynamically offering an object during a communication session according to examples and features of the instant solution.

FIG. 11 is a system diagram illustrating a computing environment according to the instant solution's example features, structures, or characteristics.

### DETAILED DESCRIPTION

The examples and features of the instant solution are directed to to intent determination based on the historical actions taken by an account risk level. An artificial intelligence model may analyze the currently requested and previous transaction behavior of the profile, and proactively prevent the profile from executing the current transaction. However, rather than suspend the account of the profile, the system can provide a different transaction (bifurcated transaction path) that reduces the potential for damage to the financial institution.

For example, the software architecture may generate a different transaction which includes a lesser amount of value, a different path through a processing network which includes more verifications, different verifications, etc., and output the different transaction to a source device which submitted the transaction. The software architecture may also continue to monitor whether the different transaction is successfully performed and provide the profile with an additional transaction to make up for the original transaction that was prevented from occurring. For example, software architecture may wait a period of time (e.g., a few days, a week, a month, etc.) and analyze whether the different transaction is successful and use the results to verify the profile.

According to various other examples and features of the instant solution, also provided herein is a software architecture which can dynamically offer an object, such as a service, a product, or the like to a profile during an ongoing communication session with a call center or contact center, such as a call center or contact center that issued a payment account to the profile. The dynamic offer may be based on past conversations between a user of the profile and the call center or contact center. As one example, the dynamic offer may be based on previous questions or requests made by the user during previous calls which have not been addressed. In this example of the instant solution, an AI model may analyze historical conversations of the user and the call center or contact center to detect potential objects of interest and provide those objects of interest as offers during a live conversation between the user and the call center or contact center. The AI model may be part of a software architecture running on a host platform which sits in a background of an ongoing communication session (such as a telephone call) between the user and a call center or contact center.

In the examples and features of the instant solution described or depicted herein, call center and contact center are used interchangeably. The call center or the contact center may receive caller communication, such as telephone calls, video calls, text messages, video, images, and the like, and may use these forms of communication to assist the caller and/or detect activity risk of the caller, dynamically triggering actions to be performed during the communication session between the caller and the call center or contact center.

In the examples and features of the instant solution described or depicted herein, an activity may include, but is not limited to, an account transaction and the like.

In the example and features of the instant solution, an activity risk may include, but is not limited to, a risk associated with account transactions, such as transactions initiated by an account holder predicted to be risky, fraudulent transactions initiated by an authorized account holder, fraudulent transactions initiated by an unauthorized or unknown party, suspicious and/or risky activity, and the like.

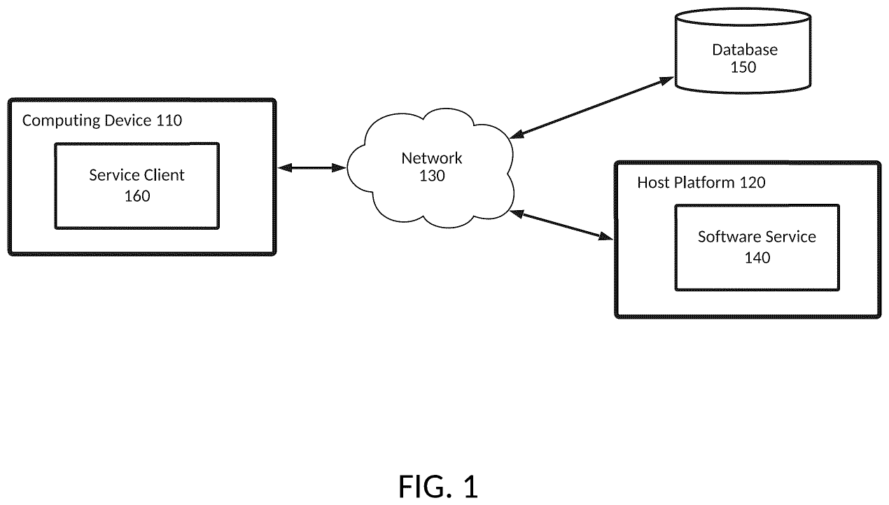

FIG. 1 is a system diagram illustrating an example operating environment of the instant solution. As shown, one or more computing devices 110, and a host platform 120 communicate via a network 130. The host platform 120 may host a software service 140. The software service 140 may communicate with one or more databases 150 through a network 130 during the course of service execution. Each computing device 110 may host a service client 160, which communicates with a corresponding software service 140.

A computing device 110 may be a mobile phone, tablet, laptop computer, desktop computer, smartwatch, vehicle infotainment system, or any computing device including a processor and memory. The host platform 120 may include a single physical server, multiple physical servers, a cloud hosting environment, or a hybrid hosting environment in which some components of the host platform 120 are “on-premise” while others are cloud-hosted. The network 130 is a computer network and may include one or more interconnected computer networks. For example, network 130 may be or may include an Ethernet network, an asynchronous transfer mode (ATM) network, a wireless network, a telecommunications network or the like.

The software service 140 provides the service logic. It may provide one or more Application Programming Interfaces (APIs) for communicating with one or more service clients 160. A “thick” user interface client that runs on a computing device 110 may utilize the APIs to communicate with the software service 140. Further, the software service 140 may provide hosted User Interfaces (UIs) that can be accessed through browser-based software on some computing devices 110.

The one or more service clients 160 can enable service access for end users and may come in a variety of forms including, but not limited to, a mobile device application (“app”) or a web portal accessed via a browser on a computing device 110 such as a laptop or desktop computer.

Detailed descriptions of the software architecture for offering different transactions and for dynamically offering products during an ongoing communication session in the instant solution are further described and depicted herein.

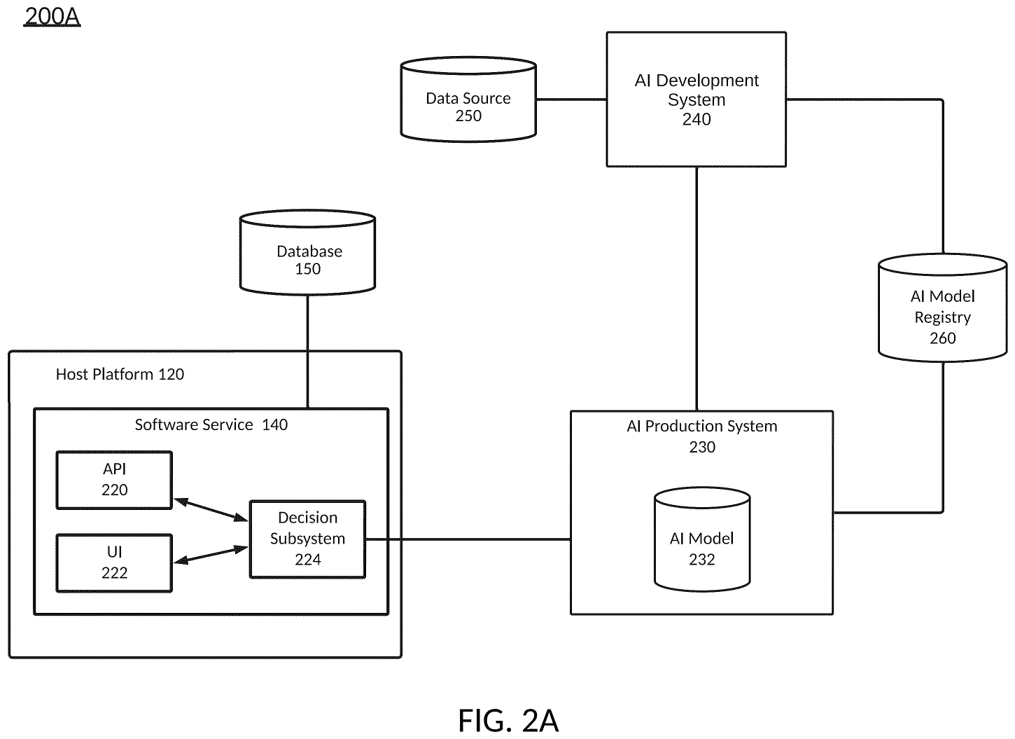

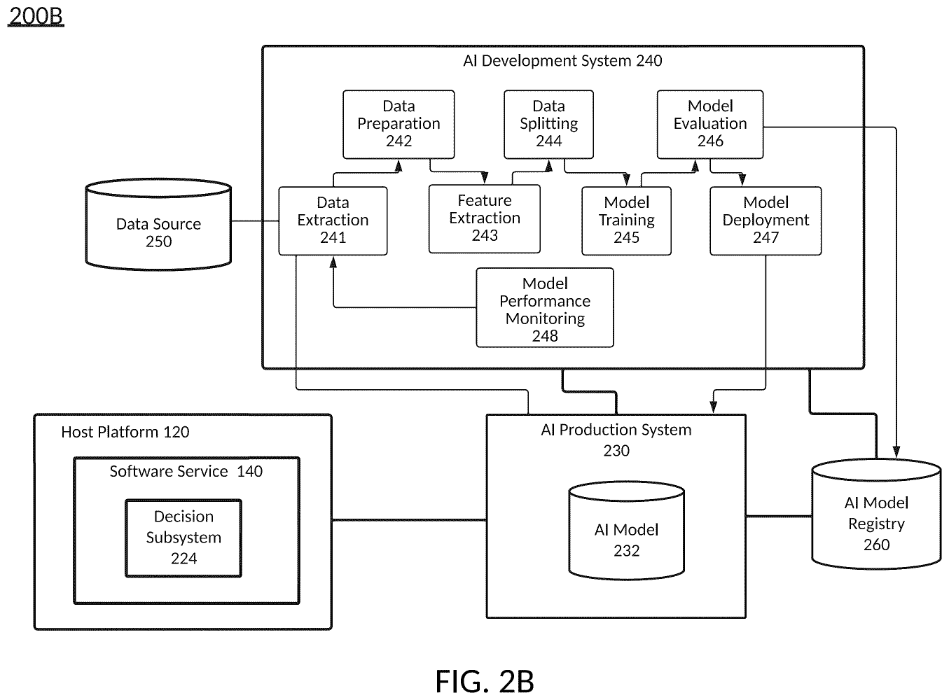

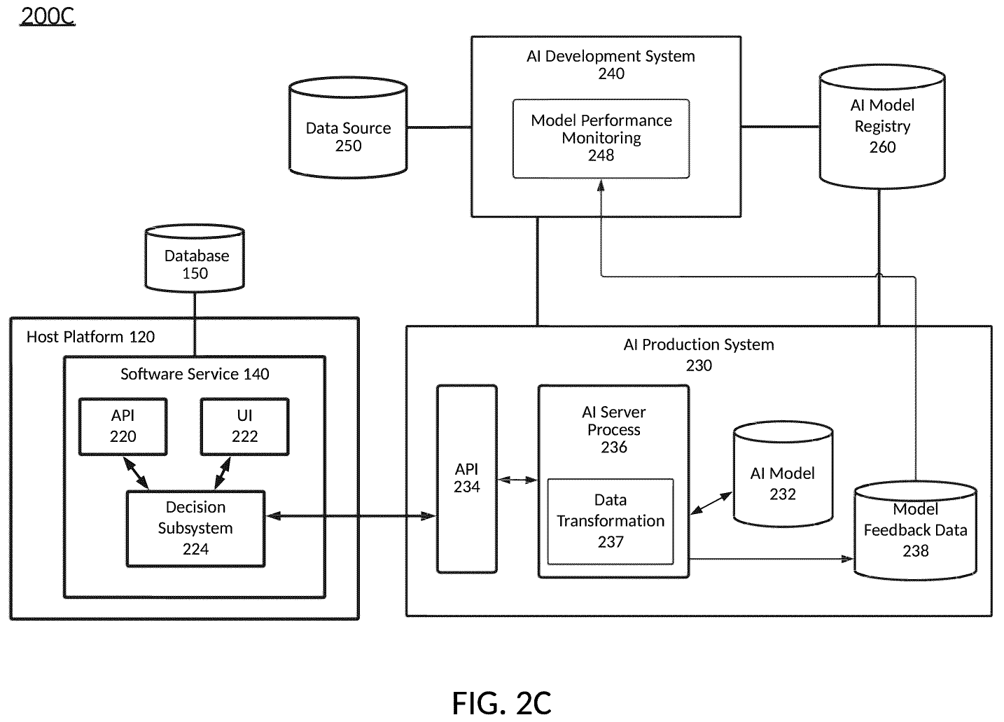

FIG. 2A illustrates an artificial intelligence (AI) network diagram 200A that supports AI-assisted decision points in a software service executing on a computer. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 140 (see FIGS. 1, 2A), executing on host platform 120 (see FIGS. 1, 2A) may provide one or more application programming interfaces (APIs) 220 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 220 send data to one or more decision subsystems 224 of the software service 140 to assist in decision-making. In some examples and features of the instant solution, the software service 140 stores data included in API requests or data generated during processing the API requests into one or more databases 150 (see FIGS. 1, 2A).

Software service 140 may provide one or more user interfaces (UIs) 222, such as a server-side hosted graphical user interface (GUI). In some examples and features of the instant solution, the UIs 222 provided employ template-based frameworks, component-based frameworks, etc. In some examples and features of the instant solution, these UIs 222 send data to one or more decision subsystems 224 of the software service 140 to assist with decision-making. In some examples and features of the instant solution, the software service 140 stores data included in UI requests or data generated during processing the UI requests into one or more databases 150.

Software service 140 may include one or more decision subsystems 224 that drive a decision-making process of the software service 140. In some examples and features of the instant solution, the decision subsystems 224 receive data from one or more APIs 220 as input into the decision-making process. In some examples and features of the instant solution, a decision subsystem 224 may receive data from one or more UIs 222 as input to the decision-making process. A decision subsystem 224 may gather service configuration or historical execution data from one or more databases 150 to aid in the decision-making process. A decision subsystem 224 may provide feedback to an API 220 or a UI 222.

An AI production system 230 may be used by a decision subsystem 224 in a software service 140 to assist in its decision-making process. The AI production system 230 includes one or more AI models 232 that are executed to generate a response, such as, but not limited to, a prediction, a categorization, a UI prompt, etc. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates one or more AI models 232. In some examples and features of the instant solution, the AI development system 240 utilizes data from one or more data sources 250 to develop and train one or more AI models 232. The data sources 250 may be local or third-party data sources. Further, the data provided by the data sources may be real-world or synthetic. In some examples and features of the instant solution, the AI development system 240 utilizes feedback data from one or more AI production systems 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by one or more AI production systems 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing one or more AI models that support AI-assisted decision points. An AI development system 240 executes steps to develop an AI model 232 that begins with data extraction 241, in which data is loaded and ingested from one or more data sources 250. In some examples and features of the instant solution, historical model feedback data is extracted from one or more AI production systems 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 242 may be a manual process or an automated process using one or more of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using one or more of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to one or more algorithm parameters until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. In some examples and features of the instant solution, one or more unseen validation datasets are used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using one or more of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to one or more AI production systems 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes one or more triggers that result in the AI model 232 being updated by repeating steps 241-248 with updated data from one or more data sources 250.

FIG. 2C illustrates a process 200C for utilizing an AI model that supports AI-assisted decision points. As stated previously, the AI model utilization process depicted: herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 140 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 140, UI 222 data from software service 140 or data from other software service 140 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 140. In some examples and features of the instant solution, the response may result in an update to a UI 222 in software service 140. In some examples and features of the instant solution, the response includes a request identifier that can be used later by the software service 140 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the: feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

In some examples and features of the instant solution, the AI production system 230 includes a user interface (not shown). The user interface may be used to manage the production system infrastructure, the components of the production system 230-238, and the operation of the AI production system and its components.

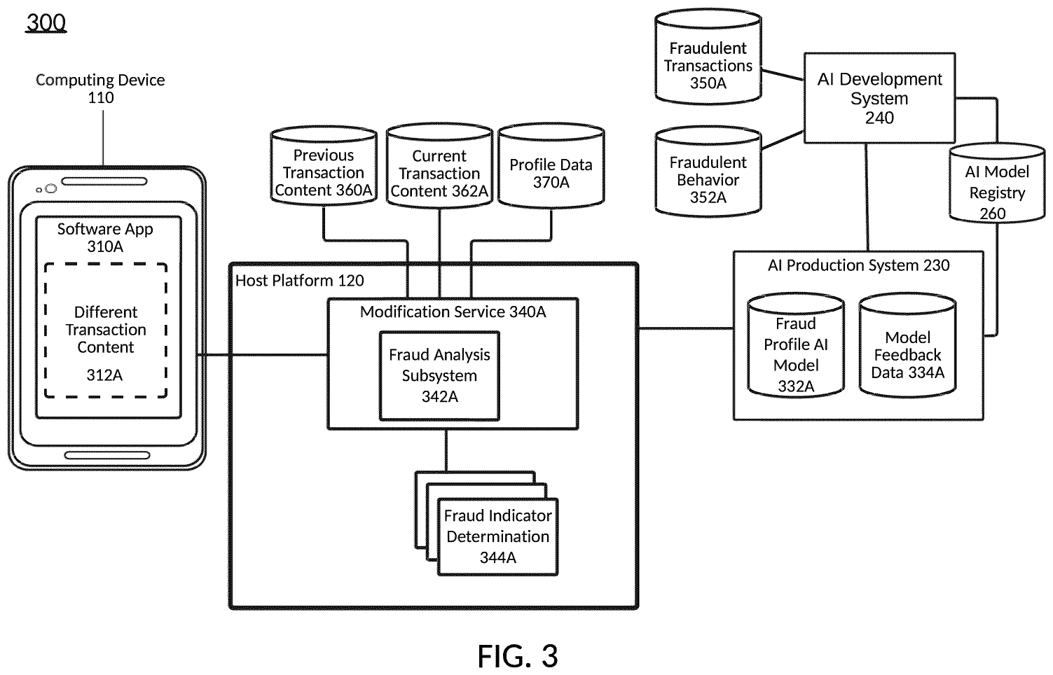

FIG. 3 is a system diagram illustrating an operating environment 300 for a modification service 340A that determines a fraud indicator for a profile based on transaction behavior and offers a different transaction than which is requested according to examples and features of the instant solution. In operating environment 300, a fraud profile AI model 332A is trained to predict a fraud indicator of a profile (e.g., a user, an account, etc.) using content from a current transaction, previously transactions, and the like, of the profile. For example, the current transaction may deviate from typical behavior of the profile as identified from the previous transactions.

Referring to FIG. 3, in some examples and features of the instant solution, a fraud profile AI model 332A is trained using historical fraudulent transactions data 350A (known fraudulent transactions), historical fraudulent behavior 352A (known patterns of behavior that are associated with fraud such as sequences of transactions, etc.), and model feedback data 334A to generate a fraud indicator for a current transaction given a set of feature data transformed from at least one of the current transaction, previous transaction history, a profile of the user, and the like. The fraud profile AI model 332A is an example of AI model 232 (see, for example, FIGS. 2A-2C). The model feedback data 334A is an example of model feedback data 238 (see, for example, FIG. 2C). The historical fraudulent transactions data 350A and the historical fraudulent behavior 352A are examples of data source 250 (see, for example, FIGS. 2A-2C). The previous transaction content 360A, current transaction content 362A, and profile data 370A are examples of database 150 (see, for example, FIG. 1, 2A, 2C). The modification service 340A is an example of software service 140 (see, for example, FIG. 1, 2A-2C). The fraud analysis subsystem 342A is an example of decision subsystem 224 (see, for example, FIGS. 2A-2C). The software app 310A is an example of service client 160 of computing device 110 (see, for example, FIG. 1, 2A-2C).

In some examples and features of the instant solution, the fraud profile AI model 332A is trained using one or more neural network training methods such as, but not limited to, gradient descent, stochastic gradient descent, random search, uniform search, basin hopping, and Krylov. In some examples and features of the instant solution, the fraud profile AI model 332A is a single or multi-layer perceptron neural network, a feed-forward neural network, a radial basis functional neural network, a recurrent neural network, or a modular neural network.

In some examples and features of the instant solution, the fraud profile AI model 332A may include, but is not limited to, at least one of a machine learning model, a deep learning model, a neural network, any combination of models from the branches of AI, and the like, and it may be trained using at least one of the respective training methods for machine learning models, deep learning models, neural networks, any combination of models from the branches of AI, and the like. In some examples and features of the instant solution, the training data may include, but is not limited to, at least one of historical fraudulent transactions of other profiles/users, historical fraudulent behavior such as patterns of transactions, context of transactions, etc. of other profiles/users, model feedback data, and the like. Here, the model feedback data may indicate whether the different transaction provided by the system is used for fraud or whether it is performed successfully without fraud. This may indicate to the system that the original decision to prevent the original transaction was correct or incorrect. In some examples and features of the instant solution, the training data for the fraud profile AI model 332A may include, but is not limited to, internal data sources, external data sources, private data sources, public data sources, account data, third party data, configuration data, or the like.

In some examples and features of the instant solution, the historical fraudulent transactions may include transaction data, user data, profile data, device data, and the like, of transactions that are known to include fraud. The historical fraudulent transaction behavior may include, but is not limited to, device data such as media access control (MAC) addresses of a computing device that conducted fraud, internet protocol (IP) addresses of one or more computing devices that conducted fraud, geographic location data of a device that conducted fraud, patterns of transactions and other requests (e.g., requested changes in passwords, login attempts, types of transactions submitted, amount of transactions submitted, value included in the transactions, etc.).

The model feedback records in the model feedback data 334A may include, but is not limited to, an indicator of whether the prediction made by the fraud profile AI model 332A is correct or not. For example, when the fraud profile AI model 332A initially predicts that a transaction has a potential for fraud, a different transaction may be offered. When the profile chooses to accept the different transaction and/or the different transaction is successfully performed without fraud, the host platform may use this knowledge to determine that the initial prediction of the potential for fraud is incorrect. This data may be used to retrain the fraud profile AI model 332A. As another example, when the profile chooses not to accept the different transaction or the profile does not successfully perform the different transaction, the host platform may use this knowledge to determine the initial prediction for fraud may be correct.

In some examples and features of the instant solution, the generated fraud indicator may be a numerical value within a given numerical range, a finite set of categories, etc. Once the fraud profile AI model 332A is trained and validated, it is deployed to an AI production system 230 (see, for example, FIGS. 2A-2C, 3) for use by the modification service 340A. The modification service 340A is an example of software service 140 (see, for example, FIG. 1, 2A-2C).

In some examples and features of the instant solution, the user accesses the host platform through a software app 310A on the computing device 110 of the user. The software app 310A, running on computing device 110, is an example of service client 160 (see FIG. 1). In some examples and features of the instant solution, when requesting a transaction, a user may use a mobile app, web app, or the like on the computing device 110 to submit a transaction to the computing device 110.

In some examples and features of the instant solution, the modification service 340A receives content from the computing device 110 including the currently requested transaction. In some examples and features of the instant solution, the modification service 340A may also receive device data (context) from the computing device 110 which may include, but is not limited to, the media access control (MAC) address, an Internet protocol (IP) address, a geographic location, and the like. Once a set of required data for fraud indicator prediction is received, a fraud analysis subsystem 342A of the modification service 340A initiates a fraud indicator determination request for the fraud profile AI model 332A resident on the AI production system 230 (see, for example, FIGS. 2A-2C, 3), supplying the set of required data. In some examples and features of the instant solution, the modification service 340A may continue to receive and process data from the computing device 110 in parallel to the fraud indicator being generated.

In some examples and features of the instant solution, upon receiving the request, the AI production system 230 (see FIGS. 2A-2C, 3) transforms 237 (see FIG. 2C) the set of required data into a set of valid feature values in the fraud profile AI model 332A. The fraud profile AI model 332A is then executed with the transformed data, the result of which is a fraud indicator such as a score, a category, or the like. In some examples and features of the instant solution, the fraud indicator is returned in a response to the fraud analysis subsystem 342A of the modification service 340A. Here, the modification service 340A may generate a different transaction and provide different transaction content 312A to the computing device 110. The computing device 110 may accept the different transaction by inputting a command on the different transaction content 312A displayed on the computing device 110. In some examples and features of the instant solution, the different transaction includes a request identifier that can be used by the modification service 340A to correlate feedback from a call center representative, or someone subsequently reviewing the different transaction, etc. and to provide feedback on the performance of the fraud profile AI model 332A. For example, the feedback may include an indicator of whether the different transaction was successfully performed (indicating the model was correct) or whether the different transaction was not successfully performed (indicating that the model was incorrect).

In some examples and features of the instant solution, upon receiving the transaction from the computing device 110, the fraud analysis subsystem 342A determines at least one fraud indicator determination 344A to be performed and in parallel the modification service 340A may continue to receive and process data from the computing device 110. In some examples and features of the instant solution, the fraud analysis subsystem 342A utilizes a set of rules and the previous transaction content 360A, current transaction content 362A (received from the computing device 110), and/or profile data 370A (of a user/account of the computing device 110), to determine the at least one fraud indicator determination 344A to be performed. The previous transaction content 360A may be stored in a data store such as database 150 depicted in FIG. 1. In some examples and features of the instant solution, rules are identified using fraud level numeric ranges. In some examples and features of the instant solution, rules are identified using a finite set of fraud categories.

In some examples and features of the instant solution, the one or more fraud indicator determinations 344A are initiated. In some examples and features of the instant solution, the fraud indicator determination 344A utilizes the profile data 370A to validate the user's identity. This profile data 370A may be associated with the user, or persons related to the user (such as a person associated with the user on a joint account). In some examples and features of the instant solution, the fraud indicator determination 344A utilizes profile data 370A that may include, but is not limited to, identity data, property records, financial account data, transaction history, and credit reporting data.

In some examples and features of the instant solution, after all of the at least one fraud indicator determinations 344A are completed, a GUI of the computing device 110 being used by the user may be updated with a different/modified transaction that reflects a final result of the at least one fraud indicator determinations 344A. In some examples and features of the instant solution, the GUI is updated when the final result of the at least one fraud indicator determination 344A is determined.

In some examples and features of the instant solution, all of the at least one fraud indicator determinations 344A must be successful in order for the final result to be considered successful. In some examples and features of the instant solution, a fraud indicator determination 344A is considered incomplete when a technical issue prevents its timely completion and an incomplete fraud profile/fraud indicator results in a failed final result. In some examples and features of the instant solution, an incomplete fraud indicator determination 344A does not impact the final result when a minimum number of the at least one fraud indicator determination 344A completes successfully.

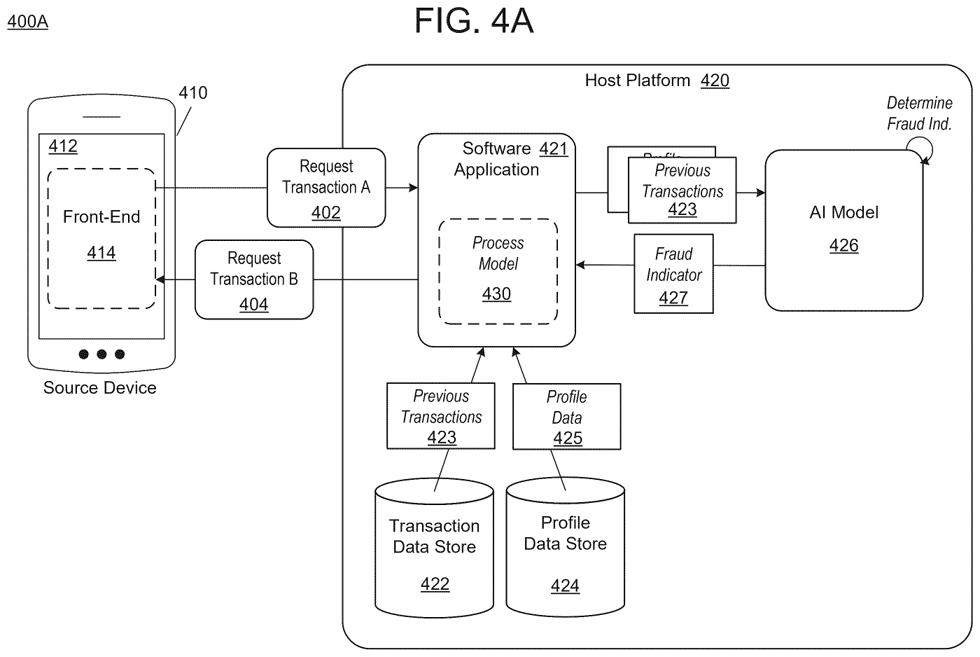

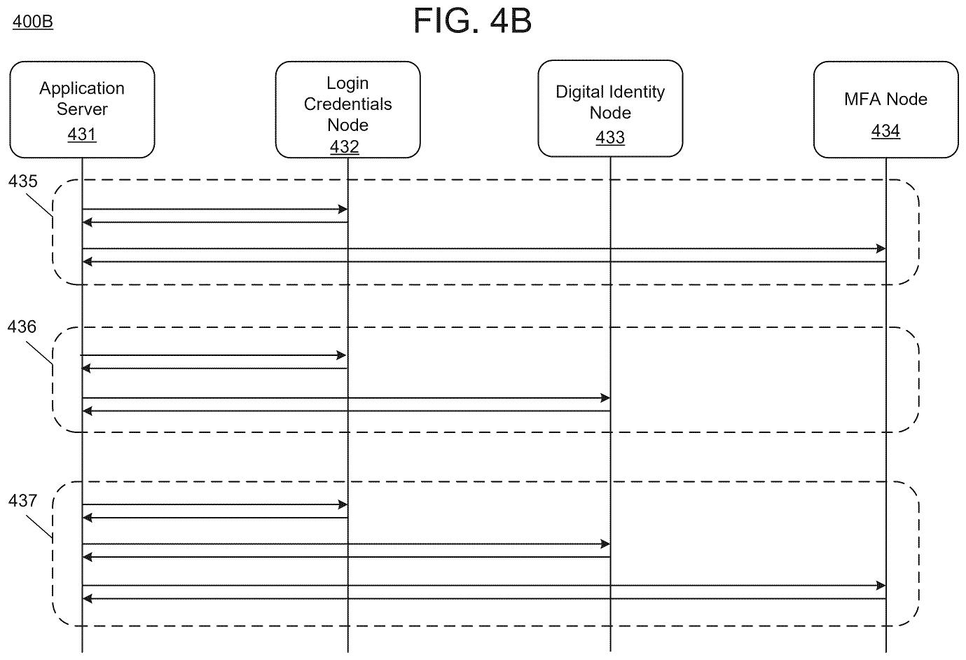

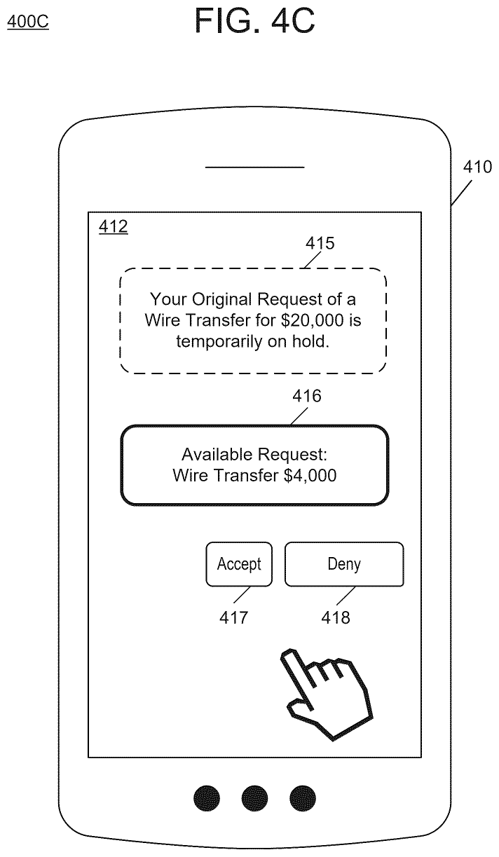

FIGS. 4A-4C illustrate a process of generating a different transaction with a different transaction path according to examples and features of the instant solution. Referring to FIG. 4A, in some examples and features of the instant solution, the host platform 420 is an example of a combination of host platform 120 and AI production system 230 (see, for example, FIGS. 2A-2C, FIG. 3). The software application 421 is an example of modification service 340A (see, for example, FIG. 3). The AI model 426 is an example of fraud profile AI model 332A (see, for example, FIG. 3). The source device 410 is an example of computing device 110. The front-end 414 is an example of the service client 160 (see, for example, FIG. 1, 2A-2C). Transaction data store 422 and profile data store 424 are examples of databases 150 (see, for example FIG. 1, 2A, 2C).

For example, FIG. 4A illustrates a process 400A of a source device 410 submitting a transaction request 402 with an original transaction to a software application 421 hosted on a host platform 420. Here, the software application 421 may correspond to a back-end of a front-end 414 of a software application that is installed or otherwise running on the source device 410. For example, the source device 410 may download and install the front-end 414 of the software application from an application marketplace, or the like.

In response to receiving the transaction request 402, the software application 421 may identify an attribute of an account, user, profile, etc. within the transaction request 402 and retrieve previous transactions 423 and profile data 425 using the attribute. For example, the attribute may include a name, an account number, a wallet identifier, a phone number, an email address, and/or the like, which are included within the transaction request 402. The software application 421 may retrieve the previous transactions 423 from a transaction data store 422 based on the attribute. In addition, the software application may retrieve the profile data 425 from a profile data store 424 based on the attribute. The software application 421 may provide the transaction request 402, the previous transactions 423, and the profile data 425 to an AI model 426.

According to various examples and features of the instant solution, the AI model 426 may be trained to predict a fraud indicator of the transaction request 402 based on at least one of the transaction request 402, the previous transactions 423, and the profile data 425. Here, the AI model 426 may generate a fraud indicator 427 of the transaction request 402 and provide the fraud indicator 427 to the software application 421. In response to receiving the fraud indicator 427 from the AI model 426, the software application 421 may generate a different transaction than what is originally requested by the source device 410.

According to various examples and features of the instant solution, the software application 421 may change, bifurcate, modify, etc. a transaction path of the transaction to increase verification, reduce liability, and/or the like. In this example, the software application 421 may query a process model 430 of transaction paths of a processing network (shown in FIG. 4B) which verifies transactions. By querying the process model 430, the software application 421 may identify verifications that are typically performed for the original transaction included in the transaction request 402 and generate a different transaction path to perform additional verifications, different verifications, or the like.

The software application 421 may use the process model 430 to generate the different transaction which includes a different transaction path through the processing network. In addition, the software application 421 may also modify a value being requested by the original transaction included in the transaction request 402. Thus, the software application 421 may reduce liability to the financial institution by modifying the value (reducing the value to a lesser value) and by simultaneously increasing the security steps/verification actions that are performed on the transaction. The software application 421 may transmit a different transaction request 404 to the source device 410 which causes the front-end 414 of the software application to display a confirmation request on a GUI 412 of the source device 410. The user of the source device 410 may confirm the different transaction request 404 by inputting a command on the GUI 412. As another example, the user of the source device 410 may decline the different: transaction request 404 by inputting a different command on the GUI 412 of the source device 410.

In the examples and features of the instant solution, the original transaction included in the transaction request 402 may be prevented from proceeding with any of authorization, clearing and settlement. For example, a transaction may typically be authorized by an issuer of a payment account/card that is included for payment in the transaction. The authorization process may be used to verify that funds for the transaction are available in the account held by the issuer. When successfully authorized, a transaction may be moved to clearing and settlement during which financial institutions of the parties to the transaction exchange value amongst themselves to reflect the value of the transaction. Here, a first bank of the sender may send money to a second bank of a receiver, and the sender's and receiver's accounts at their respective banks may be updated.

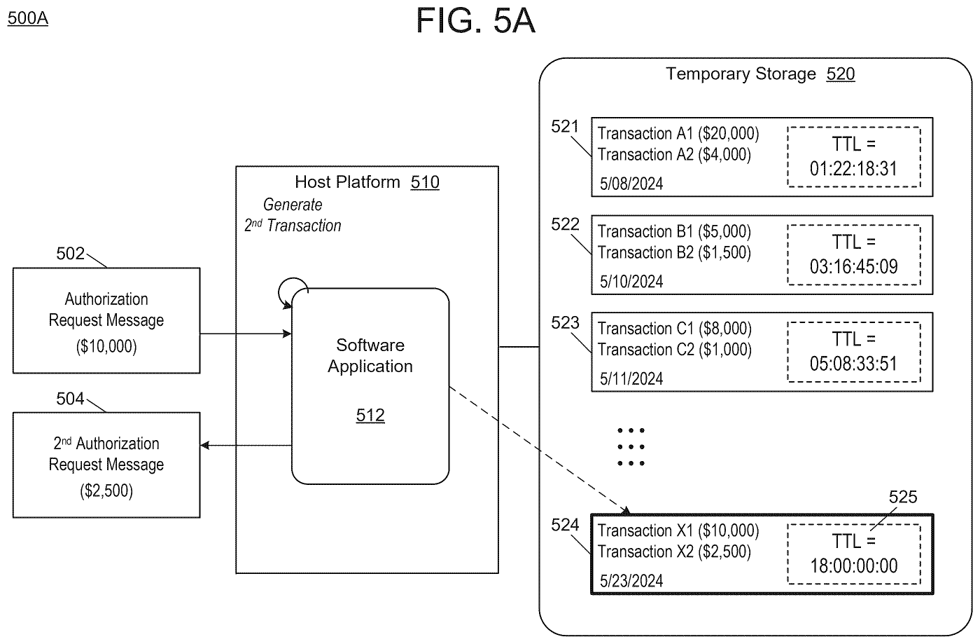

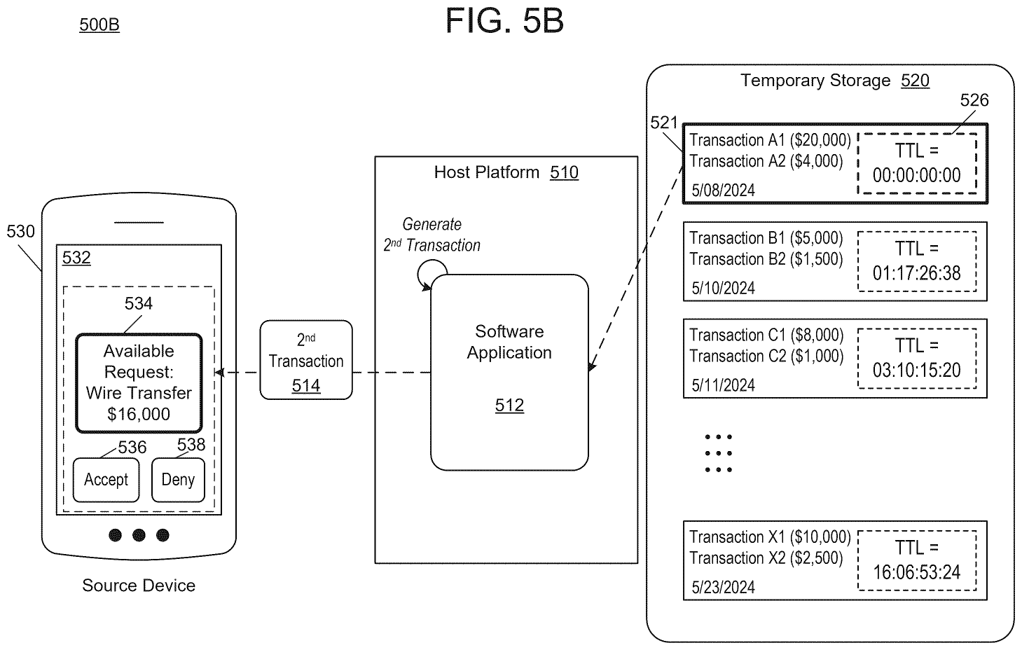

According to various examples and features of the instant solution, the authorization process and/or the clearing and settlement process may be prevented by flagging the transaction and storing it within a temporary storage structure, such as a queue. This process is further described in the examples of FIGS. 5A and 5B.

FIG. 4B illustrates a view 400B of the process model 430 shown in the example of FIG. 4A according to examples and features of the instant solution. Referring to FIG. 4B, the host platform 420 of the software application 421 may provide different transaction paths through a processing network. Here, the processing network may include an application server 431 (which hosts the software application 421), a login credentials node 432 that is configured to verify credentials submitted from the front-end 414 of the software application, a digital identity node 433 that is configured to request additional verification information from the front-end 414 of the software application such as biometrics, personal identification number (PIN), custom questions, and the like. The processing network also includes a multi-factor authentication (MFA) node 434 that is configured to request additional authentication from the source device 410 such as one-time passwords, authentication from a second device, authentication from an email account, additional questions which the user must answer, and the like.

In this example, the host platform 420 includes three different transaction paths 435, 436, and 437 which use different paths between the login credentials node 432, the digital identity node 433, and the MFA node 434, within a communication network that is wired or wirelessly implemented. It should be appreciated that the processing network shown in FIG. 4B is merely for purposes of example and is not meant to limit the scope of different processing networks that may be available to the host platform. In some examples and features of the instant solution, the processing networks may include nodes with software hosted by third-parties, external sources, cloud services, or the like, which can provide additional verifications of the content, the user, the source device 410, and the like.

Each of the application server 431, the login credentials node 432, the digital identity node 433, and the MFA node 434 may be located at different IP addresses within the processing network. Therefore, the different transaction paths 435, 436, and 437 may include different sequences of IP addresses when the application server 431 verifies a transaction. In this example, the software application 421 may choose a path from among the different transaction paths 435, 436, and 437 to perform additional verifications than the original transaction that was requested in the transaction request 402, thus increasing the level of verification needed.

In some examples and features of the instant solution, the different paths may be the result of different “friction points” that are implemented during the transaction process. Here, the different friction points may be generated by a rules engine that manages which friction points to activate and which friction points to not activate. The rules engine may provide a list of friction points to be activated; the software application 421 may select a processing path that will implement the selected friction points.

FIG. 4C illustrates a process 400C of displaying the different transaction request 404 on the GUI 412 of the source device 410. In this example, the front-end of the software application displays an identification bubble 415 which includes an identifier of the original transaction requested by the source device 410. Furthermore, the software application 421 also displays an identifier 416 of the different transaction with a request for confirmation of the different transaction. Here, the GUI 412 may display an accept button 417 and a deny button 418. In this example, the user may confirm the different transaction (shown in the identifier 416) by pressing the accept button 417. As another example, the user may reject the different transaction by pressing the deny button 418. Whether or not the user accepts the different transaction may be detected by the software application 421 and used to further retrain the AI model 426.

FIG. 5A illustrates a process 500A of queuing an originally requested transaction according to examples and features of the instant solution, and FIG. 5B illustrates a process 500B of providing an additional transaction based on the originally requested transaction according to examples and features of the instant solution.

When the original transaction is modified into a different transaction by the examples and features of the instant solution, the host platform may continue to monitor the process and may track the originally requested transaction. For example, the host platform may provide the user with a second transaction to make up for the difference between the originally requested transaction and the different transaction that is ultimately offered and accepted by the user. This enables the user to essentially perform the original transaction over the course of two transactions (or more when applicable).

As an example, a user may submit a transaction request 502 to wire transfer $10,000 to an account at another institution. In this example, the transaction request 502 may be submitted from an application installed on a source device (such as the source device 410 shown in FIG. 4A). Here, the request 502 may be received by a software application 512 hosted by a host platform 510 shown in FIG. 5A. In this example, the host platform 510 and the software application 512 may correspond to the host platform 420 and the software application 421 shown in FIG. 4A. Here, the software application 512 generates a different transaction (with a different transaction path) and outputs a different transaction request 504 to the source device. In this example, the different transaction included in the different transaction request 504 is accepted by the user.

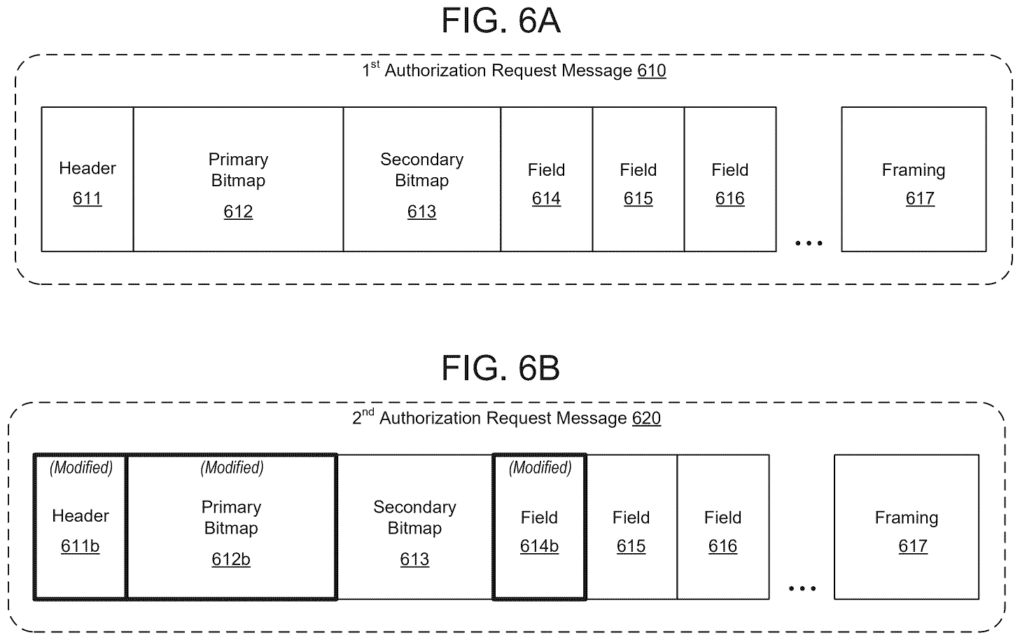

The different transaction request 504 corresponds to a different authorization request message that is going to be sent through the processing network than an authorization request message of the original transaction included in the transaction request 502. Examples of the request messages are shown and described with respect to FIGS. 6A and 6B. Referring again to FIG. 5A, the software application 512 may preserve the original transaction request 502 by creating an entry 524 and storing the entry 524 within a temporary storage 520 such as a queue. Here, the entry 524 may include an identifier of the original transaction included in the transaction request 502, an identifier of the different transaction that is included in the different transaction request 504 that is ultimately accepted by the user, a date of the transaction, a value associated with each transaction, an identifier of the user, account, profile, etc., and the like. Furthermore, the software application 512 may start a time-to-live (TTL) job 525 and add the TTL job 525 to the entry 524 within the queue.

In this example, the entry 524 may be stored after other entries 521, 522, and 523 within the temporary storage 520 based on an amount of time remaining on the queued entries. The software application 512 may use an API, or other service to enter data/entries into the temporary storage 520 and to read the TTLs included in the entries that are stored in the temporary storage 520. For example, the software application 512 may invoke an API call to the temporary storage 520 and receive identifiers of any entries with TTL jobs that have expired. As another example, the temporary storage 520 may notify the software application 512 when a queued entry has a TTL that has expired.

Referring now to FIG. 5B, the software application 512 may detect when the entry 521 (e.g., a queued transaction, etc.) expires. In this example, a TTL 526 has reached an end of the timer. In response, the temporary storage 520 may send a request to the software application 512 with the content stored in the entry 521 including the original transaction request (e.g., a wire transfer request of $20,000) and the different transaction that was ultimately approved (e.g., a wire transfer of $4,000. Here, the software application 512 may generate an additional transaction request 514 which includes a remainder of the originally requested wire transfer. Here, the additional transaction request 514 includes a wire transfer for $16,000 which is the difference between the originally requested amount ($20,000) and the previously transferred amount ($4,000).

The software application 512 may output the additional transaction request 514 to a GUI 532 on a source device (such as a GUI of a front-end of the software application) which causes an identifier 534 of the additional transaction to be displayed on the GUI 532 of the source device 530. The identifier 534 may include a description of the transaction including the type and the amount. In addition, the additional transaction request 514 may cause the front-end of the software application to display an accept button 536 and a deny button 538 which enable the user of the source device 530 to approve or reject the additional transaction. When approved, the additional transaction may be executed by the host platform 510.

FIGS. 6A-6B illustrate examples of transaction authorization messages with modified content according to examples and features of the instant solution. For example, FIG. 6A illustrates an example of a payment authorization request message 610 that corresponds to an initially requested transaction (e.g., transaction request 402 shown in FIG. 4A) by a source device/user and FIG. 6B illustrates a different payment authorization request message 620 corresponding to a different transaction (e.g., transaction request 404 shown in FIG. 4A) that is offered by the software application (such as the software application 421 in FIG. 4A) based on a fraud indicator associated with the initially requested transaction.

In this example, the payment authorization request messages 610 and 620 may adhere to the International Organization for Standardization (ISO) 8583 message format. The messages may include one or more predefined fields that adhere to the standard. For example, the payment authorization request message 610 may include one or more of a header 611, a primary bitmap 612, a secondary bitmap 613, one or more optional fields including fields 614, 615, and 616, and a framing field 617. It should be appreciated that other fields may be included in the payment authorization request message 610, and that this is just an example of such a message. Some of the fields (e.g., header 611, primary bitmap 612, and framing 617) within the payment authorization request message 610 may be required fields, while other fields (e.g., secondary bitmap 613, fields 614, 615, and 616, etc.) within the payment authorization request message 610 may be optional fields.

In this example, attributes of the initially requested payment transaction may be stored within the header 611, the primary bitmap 612, the secondary bitmap 613, the fields 614, 615, and 616, and the framing field 617. The payment authorization request message 610 may be generated by a point-of-sale system, a merchant, a mobile application, the host platform of the software application, or the like.

To generate the different transaction such as the different transaction request 404 shown in FIG. 4A, the host platform may modify one or more of the fields shown in the payment authorization request message. In the example of FIG. 6B, the host platform/software application may generate the payment authorization request message 620 by modifying data in the header 611 to generate a modified header 611b. Here, the header 611b may specify a number of bytes included in the payment authorization request message 620 and may differ based on the additional data being added to process the different payment transaction. In addition, the software may also modify the primary bitmap 612 to generate a modified primary bitmap 612b and modify an optional field such as field 614 to generate a modified field 614b. The modifications may identify different paths in the payment processing network that the payment authorization request message 620 is to traverse in comparison to the payment authorization request message 610. As another example, the modifications may identify different values of the transaction (such as lesser values, etc.).

The payment authorization request message 620 may be generated initially by the host platform, without receiving the payment authorization request message 610. However, in some examples and features of the instant solution, the host platform may receive the payment authorization request message 610 and modify the values therein to generate the payment authorization request message 620.

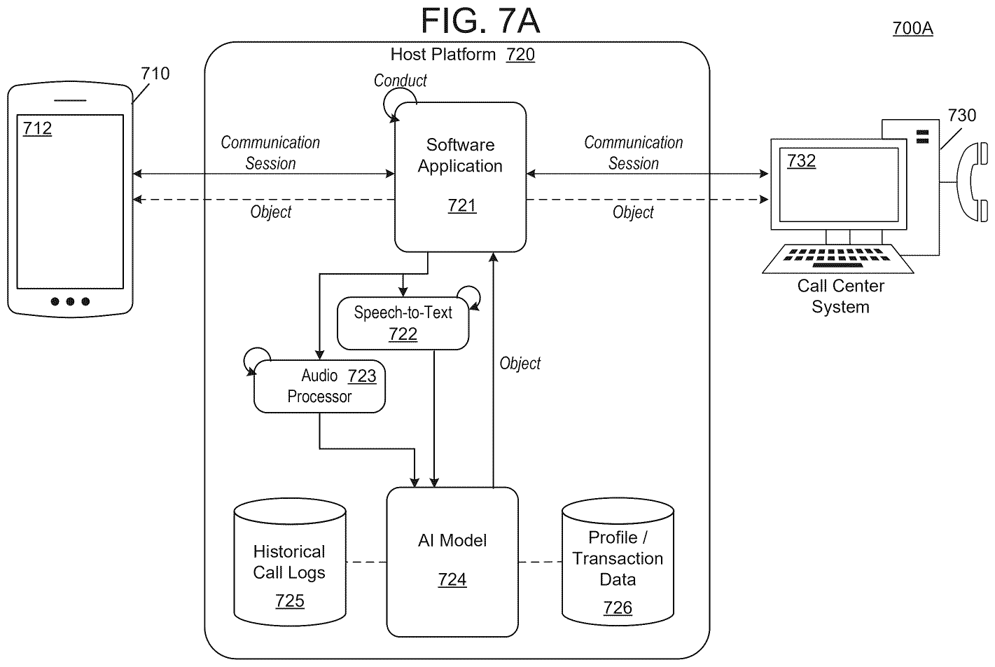

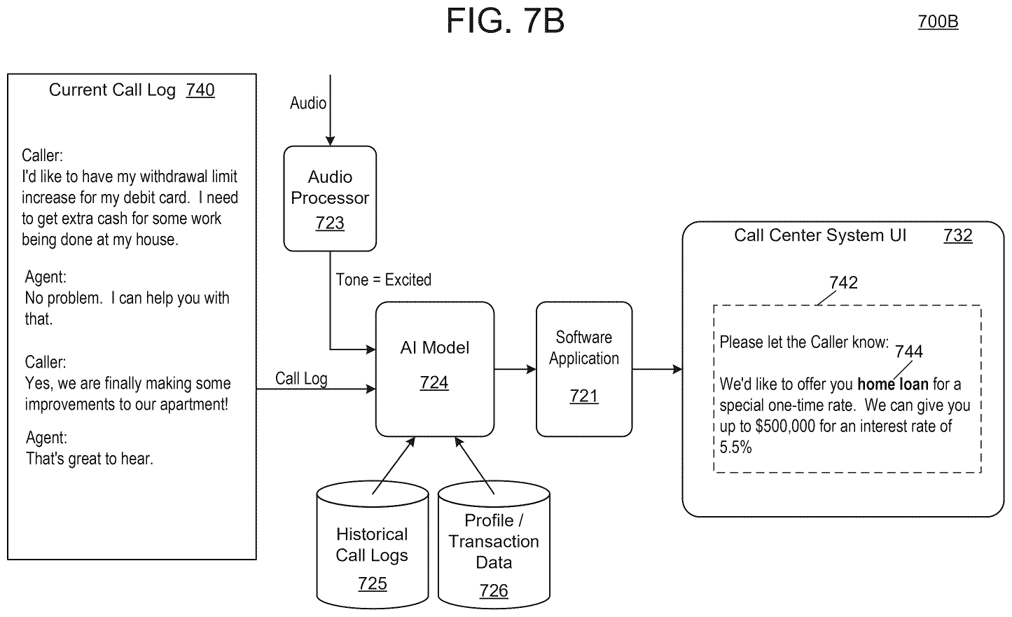

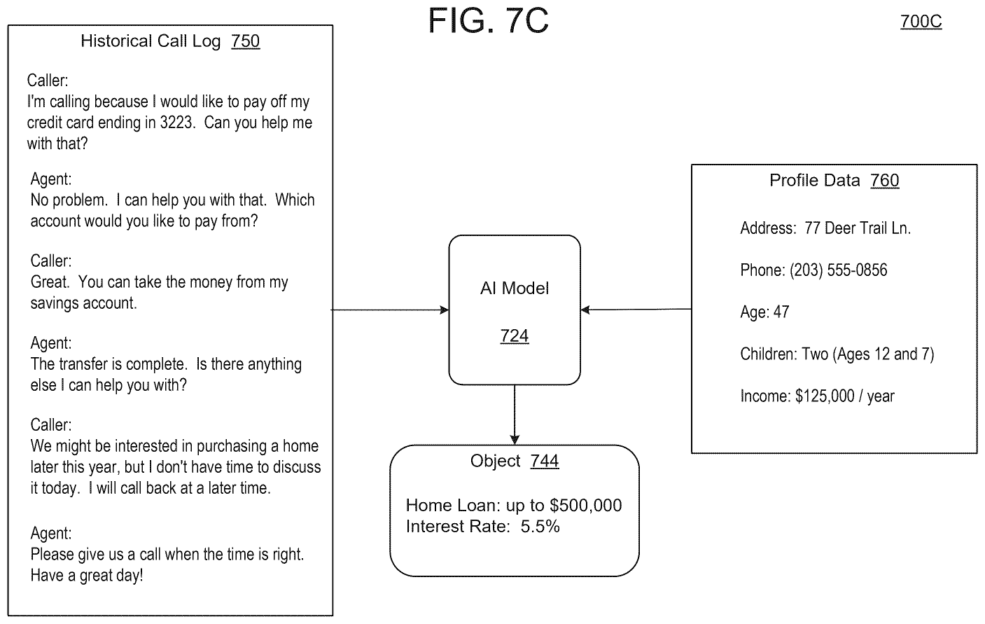

FIGS. 7A-7C illustrate a process of dynamically offering an object to a caller during a communication session according to examples and features of the instant solution. In these examples, the object may refer to a product, a service, a reward, a loyalty program, an account, or the like. In these examples, the AI model may be trained to identify objects to offer based on historical call logs where objects were offered and the callers accepted the offers. In addition to the call logs, profile data of the callers may be used to further train the model to understand financial conditions, user features, and the like, of the callers who ultimately accepted the offers for the objects. Furthermore, the AI model may be retrained, for example, based on whether an offer was accepted or whether it was rejected.

Referring to FIG. 7A, in some examples and features of the instant solution, the host platform 720 is an example of a combination of host platform 120 and AI production system 230 (see, for example, FIGS. 2A-2C). The software application 721 is an example of software service 140 (see, for example, FIG. 1, 2A-2C) that executes AI models deployed in an AI production system 230. AI model 724 is an example of AI model 232 (see, for example, FIG. 2A-2C). The source device 710 and device of the call center system 730 are examples of computing device 110, and the GUIs 712 and 732 are examples of a user interface of a service client 160 (see, for example, FIG. 1, 2A-2C) running on the computing devices. Historical call logs 725 and profile/transaction data 726 are examples of databases 150 (see, for example FIG. 1, 2A, 2C).

For example, FIG. 7A illustrates an AI architecture 700A for outputting a request for an object during a communication session based on previous communication sessions according to examples and features of the instant solution. Referring to FIG. 7A, a source device 710 may initiate a communication session with a call center by calling a phone number, using a mobile application, using a web application, or the like. Here, the source device 710 may connect to a host platform 720 via a cellular network, wireless data network, telephone network, or the like. In response, the host platform 720 may manage the call through a software application 721 hosted by the host platform. Here, the call may be assigned to a call center representative that is using the call center system 730. A communication session may occur between the source device 710 and the call center system 730 through the software application 721. The communication session may include audio being spoken, responses being entered via a GUI, chat being performed via a GUI, and the like.

According to various examples and features of the instant solution, the software application 721 may capture audio content from the communication session and send it to an AI model 724. Before being provided to the AI model 724, the audio may be processed using a speech-to-text converter 722 which converts the audio into text/transcript. In addition, the audio may be processed by an audio processor 723. The audio processor 723 may identify a tone of the conversation, for example, a tone of the customer who is on the other end of the communication session with respect to the call center representative. The text and/or the tone identified from the communication session may be submitted as inputs to the AI model 724.

According to various examples and features of the instant solution, the AI model 724 may determine an object to be output, offered, discussed, etc., during the communication session based on the content from the communication session and/or the tone of the communication session. Here, the AI model 724 may ingest previous conversation content associated with a caller of the source device 710. For example, an executable script may identify the caller from the conversation being conducted and may retrieve previous conversations of the caller from a data store of historical call logs 725. In addition, the executable script may identify a profile of the caller and retrieve it from a data store of profile/transaction data 726. The profile may be identified using a name, an account number, a telephone number, a password, a username, and the like.

According to various examples and features of the instant solution, the AI model 724 may analyze the previous call content and the profile data of the caller to identify an object (such as a product) that is of interest to the caller or a product that is not of interest to the caller. As an example, the caller may have previously discussed obtaining a savings account with a previous call center representative but may never have opened a savings account. This information can be determined from the previous calls and the profile data. Here, the AI model 724 may determine to offer the caller a savings account plan.

The AI model 724 may provide an identifier of the object to the software application 721 which is currently conducting the communication session between the source device 710 and the call center system 730. The software application 721 may display information about the object, including how to obtain the object, on a GUI 712 of the source device 710 and/or a GUI 732 of the call center system 730 while the communication session is still being performed. Here, the displayed object may include an offer to obtain the object with GUI content such as buttons, etc. which can be used to click on the offer and setup the new savings account, etc. Whether or not the offer is accepted may be recorded by the software application 721 and used to subsequently retrain the AI model 724, for example, using a similar process as shown and described with respect to FIG. 3.

FIG. 7B illustrates a process 700B of determining an object 744 to offer a caller based on a current call log 740 between the caller and the call center and based on historical call logs of the caller. Referring to FIG. 7B, a caller is discussing an increase in a withdrawal limit for a debit card account as shown in the current call log 740. The caller also mentions that they need additional money to make improvements for their apartment. The speech-to-text converter 722 may generate the current call log 740 as the caller and the call center representative are speaking. In response, the current call log 740 may be input to the AI model 724. In addition, an audio processor 723 may ingest the audio from the communication session and determine a tone of the conversation within the current call log 740. In this case, the tone is “excited”.

The tone determined by the audio processor 723 and the current call log 740 generated by the speech-to-text converter 722 may be input to the AI model 724. In addition, the AI model 724 may ingest previous call logs of the caller from a data store of historical call logs 725 and a profile of the caller from a data store of profile/transaction data 726. The previous call logs may be unrelated to the current conversation between the caller and the call center but may still contain valuable information that can be used by the AI model 724 to understand the current interests of the caller. In addition, the profile may contain information about which objects (e.g., products, services, accounts, etc.) that the caller already has and which objects the caller does not have. In addition, the profile may also contain information that can be used to determine the financial stability of the caller.

In the example of FIG. 7B, the AI model 724 determines to offer the caller an object 744 (i.e., a home loan) for a predetermined amount and with a specific interest rate. Here, the AI model 724 may provide the object 744 to the software application 721. In response, the software application 721 may display an offer 742 for the object 744 on a GUI such as the call center system UI 732 of the call center system 730. This enables the call center representative to discuss the offer of the object 744 with the caller. As another example, the offer for the object 744 may be displayed on a GUI of the source device.

FIG. 7C illustrates a process 700C of the AI model 724 generating the offer for the object 744 based on historical call log data and profile data 760 associated with the caller. In this example, the caller conducted a previous call with the call center which is represented by historical call log 750. During the previous call, the caller discussed the possibility of purchasing a home later in the year. However, this topic was never explored by the call center representative because the caller did not have time to discuss it. As another example, there are times when a call center representative may receive information about items of interest and fail to follow up with the caller, etc. In addition, the profile data 760 provides features of the user that can be used to generate the offer for the object 744.

Here, the AI model 724 may ingest the historical call log 750 and the profile data 760 along with the current call log 740, and determine the object 744 to be offered, including an amount, an interest rate, and the like.

According to various embodiments, the AI model 724 may be configured to match content within the current call log 740, the historical call log 750, the profile data 760, and the like, to a set of conditions that are stored within a table. The set of conditions may correspond to a set of conditions that, if met, determine that the profile should receive an offer for a new product. Here, the set of conditions may be paired with content associated with the offer such as a display value that identifies a type of the offer (e.g., a car loan, a savings account, a credit card, a mortgage, etc.) and dynamic values that may be dynamically determined for a particular offer based on attributes of an account holder within the profile 760.

FIG. 7D illustrates a view 700D of a table 770 that stores offer data paired with sets of conditions according to example embodiments. Referring to FIG. 7D, the table 770 may refer to a lookup table that can be accessed by at least one of the software application 721 and the AI model 724. In this example, the table 770 includes a column 772 with conditions, a column 774 with offer types (values), and a column 776 with dynamic values. Each of the columns are paired with each other. Here, the AI model 724 may identify a set of conditions stored within the column 772, and determine an offer to output during a live conversation (e.g., call, chat session, etc.) based on the content within the column 774 and/or the column 776.

Here, the AI model 724 may identify an offer stored in the column 774 that is paired with a set of conditions in the column 772 that are matched to conversation content within the live conversation. As another example, the AI model 724 may identify a dynamic value associated with the offer in the column 776 that is paired with the set of conditions in the column 772. The dynamic value may be chosen from among multiple possible values based on attributes of an account, user, profile, etc. that is associated with the live conversation.

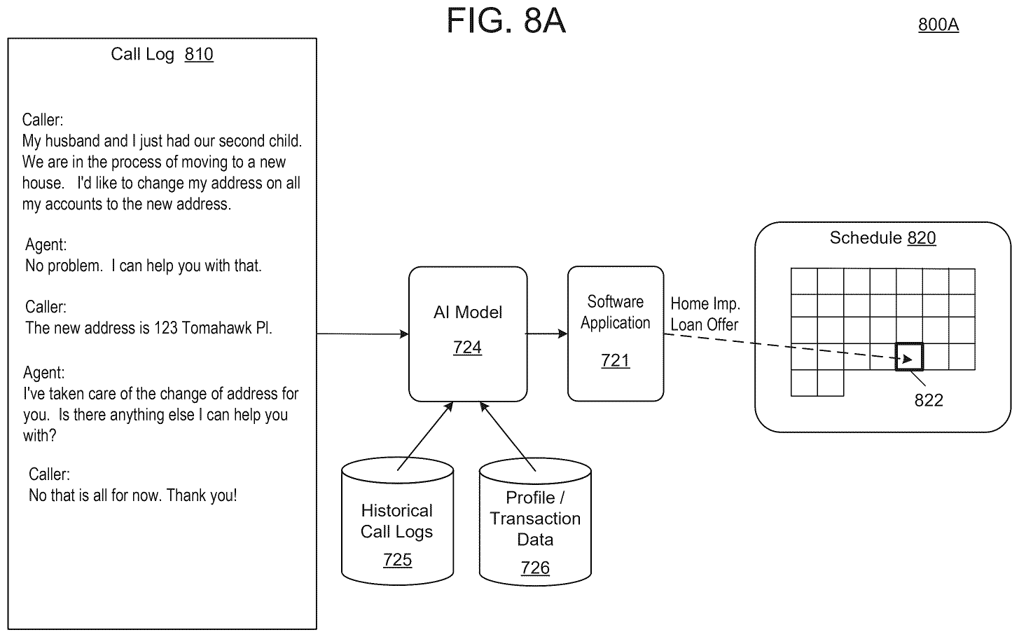

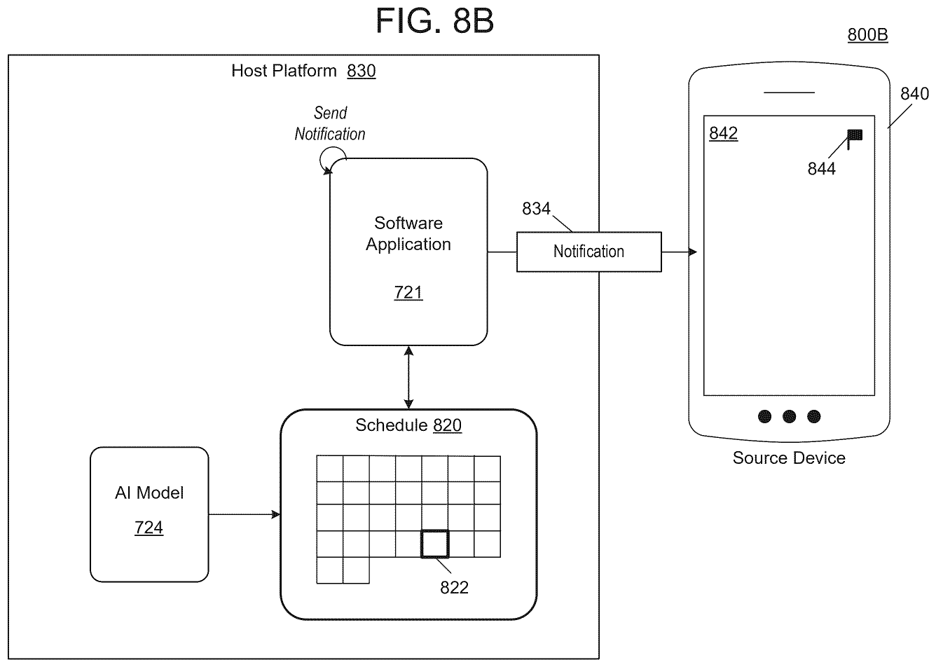

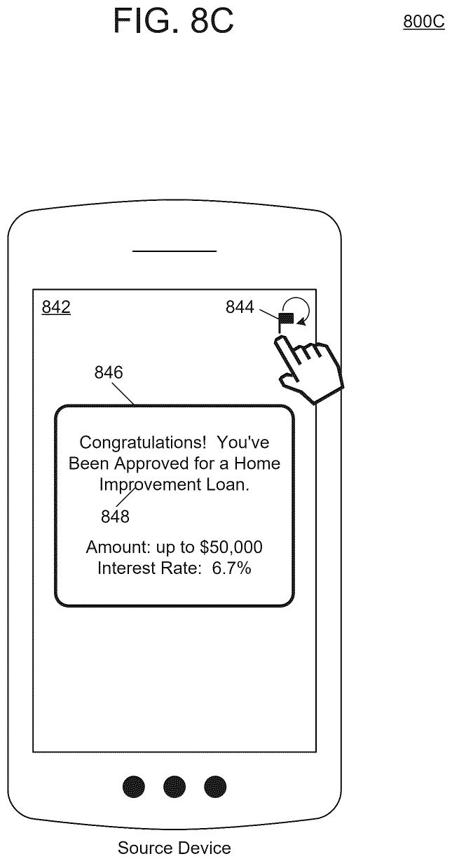

FIGS. 8A-8C illustrate a process of offering an object to a profile at a subsequent point in time according to examples and features of the instant solution. For example, the process shown and described with respect to FIGS. 7A-7C may be performed based on call log data and may be output to a computing device associated with a caller even though the caller is not currently in a communication session with the call center. In the examples of FIGS. 8A-8C, a call log can be analyzed while it is being conducted or after the fact, and the AI model 724 can generate an offer for an object that can be sent to the computing device at a later time. For example, an offer can be pushed to a computing device associated with the profile.

Referring to FIGS. 8A-8C, in some examples and features of the instant solution, the host platform 830 is an example of a combination of host platform 120 and AI production system 230 (see, for example, FIGS. 2A-2C). The software application 721 is an example of software service 140 (see, for example, FIG. 1, 2A-2C) that executes AI models deployed in an AI production system 230. AI model 724 is an example of AI model 232 (see, for example, FIG. 2A-2C). The source device 840 is an example of computing device 110, and the GUI 842 is an example of a user interface of a service client 160 (see, for example, FIG. 1, 2A-2C) running on the computing device. Historical call logs 725 and profile/transaction data 726 are examples of databases 150 (see, for example FIG. 1, 2A, 2C).

FIG. 8A illustrates a process 800A of determining an object to offer to a user/profile based on content included in a call log 810 of the user. Here, the call log 810 may be analyzed after-the-fact, for example, using an executable script and the AI model 724 discussed in the examples of FIGS. 7A-7C which is hosted by a host platform 830 shown in FIG. 8B. In this example, the call log 810 may be input to the AI model 724 and may be used to identify an object (e.g., a home improvement loan, etc.) to offer the user based on the content in the call log 810. It should also be appreciated that previous call logs from the data store of historical call logs 725 and profile data from the data store of profile/transaction data 726 may be ingested and input to the AI model 724 during execution/prediction of the object to offer.

In this example, the AI model 724 may also determine a point in time when to offer the object, such as a point in time in the future. Here, the AI model may determine the point in time based on content within the call log 810, such as a point in time when the caller mentions a need for something. As another example, the AI model 724 may be trained to “infer” the point in time in the future based on other events mentioned during the call log. In the example of FIG. 8A, the caller mentions that he/she is in the process of moving to a new home. The AI model may infer that a home improvement loan offer may be well-timed when provided a few months into the future, a few weeks into the future, etc. In this example, the AI model may provide the offer and the point in time to the software application 721 which then schedules the offer to be sent to a computing device associated with the caller using a scheduling application 820. In this example, a date 822 on which to send the offer is marked on the scheduling application 820.

FIG. 8B illustrates a process 800B of pushing a notification 834 to a computing device 840 based on the offer scheduled in the scheduling application 820 shown and described with respect to FIG. 8A. In this example, the software application 721 may detect an occurrence of the date 822, for example, based on a trigger/request from the scheduling application 820, and retrieve the offer to be provided from the scheduling application 820. In response, the software application 721 may transmit a push notification 834 to the computing device 840 with the offer. In this example, the push notification 834 triggers a display of a notification icon 844 on a GUI 842 of the computing device 840.

FIG. 8C illustrates a process 800C of a user clicking on the notification icon 844 on the GUI 842 of the computing device 840. Referring now to FIG. 8C, when a user clicks on the notification icon 844 shown on the GUI 842 of the computing device 840, details about the offer included within the notification 834 are displayed within a notification window 846 on the GUI 842 of the source device. The notification window 846 includes an identifier of the object 848, which in this example, is a home improvement loan. Here, the notification 834 may include instructions therein which cause the GUI 842 to reveal the details of the offer when the user clicks on the notification icon 844 displayed on the GUI 842. The instructions may be generated by the software application 721 and pushed to the computing device 840 over a computer network such as the Internet, a cellular network, a wireless network, or the like.

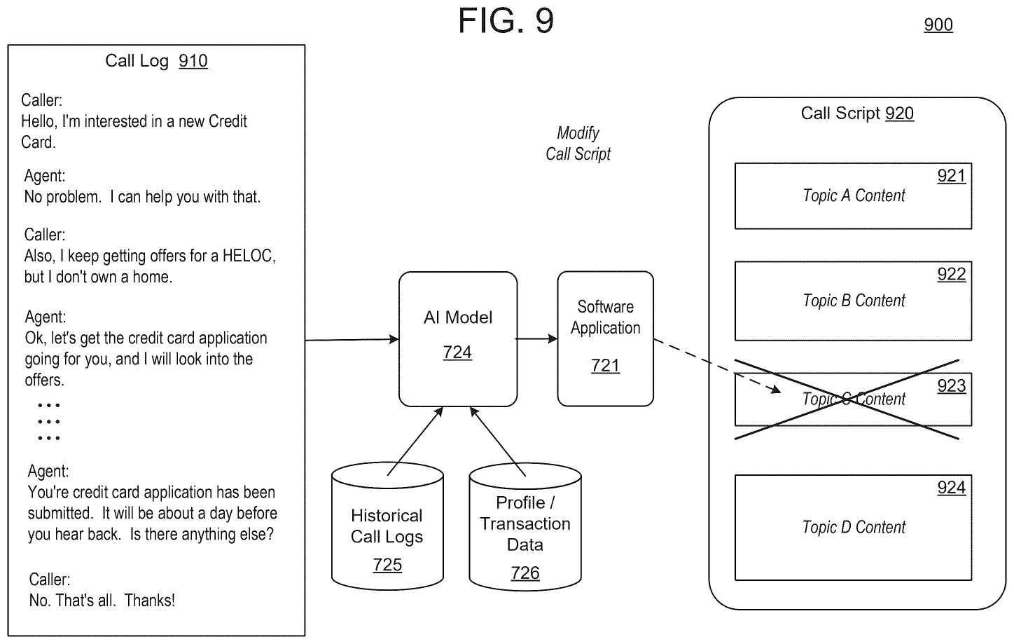

FIG. 9 illustrates a process 900 of removing content from a future correspondence based on communication content during an ongoing communication session according to examples and features of the instant solution. In some examples and features of the instant solution, the host platform may engage in communication campaigns with their customers. The campaigns may include specific content which is to be sent to the customers via email, text message, etc. It may also include content that is to be spoken to the users by an automated interactive voice response (IVR) application, a call center representative, or the like.

According to various examples and features of the instant solution, the AI model 724 may determine an object that is not of interest to the caller and may remove digital content, call content, or the like, from future messages, calls, and the like, which are communicated to the caller. For example, in FIG. 9, the AI model 724 may ingest a call log 910 of a current call that is occurring or a call that previously occurred with a caller and determine an object in which the caller is not interested. In the example of the call log 910 of FIG. 9, the caller mentions that they are not interested in a home equity line of credit (HELOC) because they do not own a home.

According to various examples and features of the instant solution, the AI model 724 may ingest the call log 910 and determine that a HELOC is not of interest to the caller and may remove content 923 from a future correspondence with the caller such as a call script 920 to be used by a call center representative or an IVR application. As another example, the AI model 724 may remove content from a digital message, email, text message, and the like. In this example, the AI model 724 sends an identifier of the object that is not of interest to the caller, and the software application 721 identifies the call script 920 with content discussing the object, and removes it. Meanwhile, the software application 721 does not remove content 921, 922, and 924 from the call script 920 because the AI model 724 did not detect that these features are not of interest.

In some examples and features of the instant solution, the instant solution comprises a memory configured to store an artificial intelligence (AI) model and a processor configured to train the AI model using a neural network training capability. The training incorporates at least one of the activity risk attributes, risk patterns of behavior, and model feedback data. The processor is also configured to receive a request to execute an activity comprising an activity risk attribute and a predefined activity path through a processing network.

In some examples and features of the instant solution, upon receiving the activity request, the processor retrieves previous activity content associated with the activity from a database. Utilizing the previous activity content along with the activity risk attribute, the processor executes the trained AI model to predict a risk level. The risk level is generated based on the likelihood of activity risk. When the risk level suggests a potential for activity risk, the processor generates a different activity that includes a lesser activity risk attribute than the original activity risk attribute. The different activity, designed to mitigate potential activity risk, is output by the processor as a request to confirm the activity on a graphical user interface (GUI) of a computing device. The GUI displays the details of the different activity and prompts the user to confirm or deny the activity, ensuring that the user is informed and involved in the decision-making process.

In some examples and features of the instant solution, the solution one or more of implements a trained artificial intelligence (AI) model through a use of a neural network training capability with at least one of activity risk attributes, activity risk patterns of behavior, and model feedback data, receives a request to execute an event comprising a first event attribute and a predefined event path through a processing network, obtains previous event content associated with the event from a database, executes an AI model on the first event attribute and the previous event content to predict an event risk level, generates a different event which includes a second event attribute than the first event attribute of the event based on the event risk level, and outputs a default automated action of the different event.

In some examples and features of the instant solution, the processor prevents the original activity from being executed while generating the different activity. It marks the queue entry with an identifier of the different activity and adds the entry to a storage queue. The processor may also determine a different processing path for the different activity through the processing network based on the risk level. This involves marking a field of an authorization request message of the different activity with an identifier of the different processing path, thereby ensuring that the activity undergoes additional verification steps as necessary. The processor is equipped to identify additional processing nodes required for handling the different activity, based on a processing model of the network. When the different activity is successfully executed, the processor can determine the remainder of the activity risk attribute based on the lesser activity risk attribute and subsequently execute a second activity for the remainder of the activity risk attribute after a predetermined period of time. Additionally, the processor continuously monitors whether the different activity includes any risk activity. It records the information in the model feedback data, which is used to retrain the AI model, thereby improving the accuracy and reliability of future risk predictions. The processor outputs a description of the different activity with a visual indicator on the GUI, highlighting that the activity has been modified to mitigate risk.

In some examples and features of the instant solution, the instant solution is configured to store an artificial intelligence (AI) model and a processor configured to train the AI model using a neural network training capability. The training involves incorporating at least one of activity risk attributes, activity patterns of behavior, and model feedback data. The processor is further configured to receive a request to execute an activity that includes an activity risk attribute and a predefined activity path through a processing network. The executed activity may be referred to herein as an executed event, wherein the term activity and event are used interchangeably.

In some examples and features of the instant solution, upon receiving the activity request, the processor retrieves previous activity content related to the activity from a database. The previous activity content, along with the activity risk attribute, is then used by the processor to execute the trained AI model and predict an activity risk level. When the activity risk level suggests a potential for activity risk, the processor simultaneously prevents the original activity from being executed. In response to the activity risk level, the processor generates a different activity that includes a lesser activity risk attribute than the original activity. The modified activity is intended to mitigate the potential activity risk while still allowing the user to complete a similar activity. The processor then creates a queue entry corresponding to the original activity and marks the entry with an identifier of the different activity. The queue entry, now associated with the different activity, is added to a storage queue. The processor ensures that the entry is properly logged and tracked within the storage system. The storage queue, which may be implemented as a temporary storage mechanism, maintains this queue entry until further action is required.

In some examples and features of the instant solution, the processor's ability to simultaneously prevent the original activity while generating and queuing a different activity is crucial in maintaining the security and integrity of the activity process. By marking the queue entry with the identifier of the different activity, the processor ensures that all related activities and monitoring can reference the correct activity, facilitating accurate tracking and follow-up actions.

In some examples and features of the instant solution, the instant solution is configured to receive a request to execute an activity that includes an activity risk attribute and a predefined activity path through a processing network. Upon receiving the activity request, the processor retrieves previous activity content related to the activity from a database. The previous activity content, along with the activity risk attribute, is then used by the processor to execute the trained AI model and predict an activity risk level. When the activity risk level suggests a potential for activity risk, the processor generates a different activity that includes a lesser activity risk attribute than the original activity risk attribute.

In some examples and features of the instant solution, the processor determines a different processing path for this newly generated different activity through the processing network based on the activity risk level. This involves selecting a processing path that includes additional or different verification steps to ensure the security and legitimacy of the activity. The processor marks a field of an authorization request message of the different activity with an identifier of this different processing path. The identifier indicates the specific route that the different activity will take through the processing network, which may involve passing through additional nodes or services for further verification. For instance, the processing path may include extra steps such as multi-factor authentication (MFA), digital identity verification, or other security checks that are not part of the original activity path.

In some examples and features of the instant solution, by determining and marking a different processing path, the processor ensures that the activity undergoes heightened scrutiny to mitigate any potential activity risks. This dynamic adjustment of the activity's route through the network provides an additional layer of security, making it more difficult for activity risks to be successfully executed. The apparatus thus effectively adapts to the identified activity risk by rerouting the activity through a more secure path, leveraging the AI model's predictions to enhance activity security. This capability allows the system to respond in real-time to potential activity risk levels, ensuring that activities are processed securely and efficiently.

In some examples and features of the instant solution, the instant solution is configured to receive a request to execute an activity that includes an activity risk attribute and a predefined activity path through a processing network. Upon receiving the activity request, the processor retrieves previous activity content related to the activity from a database. The previous activity content, along with the activity risk attribute, is then used by the processor to execute the trained AI model and predict an activity risk level. When the activity risk level suggests a potential for activity risk, the processor generates a different activity that includes a lesser activity risk attribute than the original activity risk attribute.

In some examples and features of the instant solution, to enhance the security of the different activities, the processor determines a different processing path through the processing network based on the activity risk level. This involves marking a field of an authorization request message of the different activity with an identifier of this different processing path. The different processing path is carefully selected to include additional verification steps or security checks to mitigate the identified activity risk. In determining the different processing path, the processor identifies an additional processing node for handling the different activity. The additional processing node is selected based on a processing model of the processing network, which outlines various nodes and their capabilities in verifying activity authenticity. For example, the additional processing node may be a multi-factor authentication (MFA) server, a digital identity verification service, or any other node that can provide enhanced security checks.

In some examples and features of the instant solution, the inclusion of an additional processing node ensures that the different activity undergoes more rigorous scrutiny compared to the original activity path. This step is crucial in verifying the legitimacy of the activity and preventing potential activity risks. By dynamically adjusting the processing path based on the activity risk level, the apparatus ensures that higher-risk activities are subject to more stringent verification procedures.

In some examples and features of the instant solution, the instant solution is configured to receive a request to execute an activity that includes an activity risk attribute and a predefined activity path through a processing network. Upon receiving the activity request, the processor retrieves previous activity content related to the activity from a database. The previous activity content, along with the activity risk attribute, is then used by the processor to execute the trained AI model and predict an activity risk level. When the activity risk level suggests a potential for activity risk, the processor generates a different activity that includes a lesser activity risk attribute than the original activity risk attribute.

In some examples and features of the instant solution, the processor prevents the original activity from being executed and initiates the different activity with the lesser activity risk attribute. The different activity is designed to mitigate potential activity risks while still allowing the user to perform a similar activity. The processor then tracks the execution of this different activity. Once the different activity is successfully executed, the processor determines a remainder of the activity risk attribute that was part of the original activity request. For example, when the original activity was to transfer $10,000 and the different activity that was executed successfully involved transferring $4,000, the remainder of the activity risk attribute may be $6,000. After a predetermined period of time from the successful execution of the different activity, the processor initiates a second activity for the remainder of the activity risk attribute. This predetermined period of time allows for further verification and monitoring to ensure that the initial suspicion of activity risk was not warranted. The second activity is then processed to complete the original activity request incrementally, ensuring security while also fulfilling the user's activity needs.

In some examples and features of the instant solution, the instant solution is configured to receive a request to execute an activity that includes an activity risk attribute and a predefined activity path through a processing network. Upon receiving the activity request, the processor retrieves previous activity content related to the activity from a database. The previous activity content, along with the activity risk attribute, is: then used by the processor to execute the trained AI model and predict an activity risk level. When the activity risk level suggests a potential for activity risk, the processor generates a different activity that includes a lesser activity risk attribute than the original activity risk attribute.

In some examples and features of the instant solution, to enhance the security of the different activity, the processor simultaneously prevents the original activity from being executed and generates a queue entry corresponding to the activity. The queue entry is marked with an identifier of the different activity and added to a storage queue for tracking and further processing. Once the different activity is executed, the processor determines whether the different activity includes any activity risk. This determination involves monitoring the execution and outcome of the different activity to verify its legitimacy. The processor collects data on whether the different activity was successfully executed without activity risk or when it exhibited activity risk characteristics. The collected data, including the activity, the different activity, and an indication of whether the different activity includes activity risk, is added to the model feedback data. The processor uses this model feedback data to retrain the AI model, incorporating the outcomes of different activities to improve the accuracy and reliability of future activity risk predictions. This continuous learning process ensures that the AI model becomes more effective over time in detecting and preventing activity risk.

In some examples and features of the instant solution, the instant solution is configured to receive a request to execute an activity that includes an activity risk attribute and a predefined activity path through a processing network. Upon receiving the activity request, the processor retrieves previous activity content related to the activity from a database. The previous activity content, along with the activity risk attribute, is then used by the processor to execute the trained AI model and predict an activity risk level. When the activity risk level suggests a potential for activity risk, the processor generates a different activity that includes a lesser activity risk attribute than the original activity risk attribute.

In some examples and features of the instant solution, the processor prevents the original activity from being executed and initiates the different activity with the lesser activity risk attribute. The different activity is intended to mitigate potential activity risks while still allowing the user to perform a similar activity. The processor generates a queue entry corresponding to the original activity and marks this entry with an identifier of the different activity, which is then added to a storage queue for tracking and further processing. To ensure transparency and user involvement, the processor outputs a description of the different activity on a graphical user interface (GUI) of a computing device. This description includes a visual indicator that clearly indicates the activity is being limited to the different activity. The visual indicator helps the user understand that the original activity has been modified to reduce the potential for activity risk.

In some examples and features of the instant solution, the GUI displays details of the different activity, including the reason for the modification and any relevant information about the activity risk attribute changes. The interface allows the user to confirm or reject the different activity, providing an opportunity to review and understand the modifications before proceeding. The visual indicator is designed to enhance user awareness and trust by making it clear that the activity has been adjusted for security reasons.

In some examples and features of the instant solution, the instant solution comprises an apparatus with a memory and a processor, which together enable the training and deployment of the AI model for dynamic, real-time interaction with users based on historical and ongoing conversation data. The memory component of the apparatus is configured to store the AI model, which is trained using a neural network training capability. The training process involves the utilization of call logs from historical conversations, identifiers of objects that were offered during those conversations, the specific points in time when the objects were offered, and model feedback data. The comprehensive training dataset allows the AI model to learn and predict the most relevant objects to offer during future conversations.

In some examples and features of the instant solution, the processor receives conversation content from an ongoing communication session with a computing device associated with a user profile. The content can be in the form of speech during a telephone call, which the processor is capable of converting to text for further analysis. Once the conversation content is obtained, the processor accesses a database to retrieve previous conversation content associated with the user profile. The historical data provides context and aids the AI model in making accurate predictions. The trained AI model is executed by the processor, which analyzes both the ongoing conversation content and the retrieved historical conversation content to determine a suitable object to offer to the user. The AI model's prediction takes into account various factors such as the user's past interactions, preferences, and the context of the current conversation.

In some examples and features of the instant solution, to present the predicted object to the user, the processor outputs a selectable option via a GUI at a strategic point during the ongoing communication session. The GUI can be part of a software application running on the user's computing device, enabling real-time interaction and decision-making. For instance, during a telephone call conducted via a software application, the processor receives and converts the speech to text. The AI model processes the text along with historical data to predict an object of interest. The software application displays the selectable option on the GUI, allowing the user to easily accept or reject the offer during the call. The processor adds a model feedback record, which includes details of the conversation content, previous conversation content, the object offered, and whether the selectable option was chosen by the user. The feedback is used to continuously retrain the AI model, enhancing its accuracy and effectiveness over time.

In some examples and features of the instant solution, the instant solution is configured to process telephone call content in real time, convert the content to text, and dynamically present relevant options to the user via a software application. The processor receives conversation content from an ongoing telephone call conducted via a software application on a computing device associated with a user profile. The software application facilitates the communication session and captures the spoken content of the telephone call. The processor employs a speech-to-text conversion module to transform the spoken words into textual data. The conversion allows the model to process the conversation content in a structured format.

In some examples and features of the instant solution, once the conversation content is converted to text, the processor retrieves previous conversation content related to the user profile from a database. The historical data provides context and background, enabling the AI model to make more accurate predictions based on the user's past interactions and preferences. The trained AI model, stored in the memory, is executed by the processor. The model analyzes the current conversation content in text form alongside the historical conversation content. The analysis allows the AI model to identify a suitable object to offer to the user during the ongoing telephone call. The object's relevance is determined based on various factors, including the user's previous requests, preferences, and the context of the current conversation.

In some examples and features of the instant solution, after the AI model determines the object to be offered, the processor outputs a selectable option to obtain the object via the GUI of the software application. The GUI is typically integrated into the software application running on the user's computing device, allowing for seamless interaction during the call. The selectable option is presented in real-time, providing the user with an immediate opportunity to accept or reject the offer while still engaged in the conversation. For instance, during a telephone call, the processor continuously receives and converts the speech to text. The AI model processes the text along with the historical data to predict an object of interest. The software application displays the selectable option on the GUI, which may include buttons or other interactive elements, enabling the user to respond to the offer without interrupting the call. The apparatus includes mechanisms for feedback integration. The processor adds a model feedback record that encompasses details such as the conversation content, previous conversation content, the object offered, and whether the selectable option was chosen by the user. The feedback is used to retrain the AI model.

In some examples and features of the instant solution, the instant solution is configured to modify future correspondences based on the analysis of ongoing and historical conversation content, ensuring that irrelevant or redundant information is removed before the correspondence is sent. The apparatus comprises a memory for storing the AI model and a processor configured to perform a sequence of operations. The processor receives conversation content from an ongoing communication session conducted via a software application on a computing device associated with a user profile. The content can include spoken words, chat messages, or other forms of interaction that occur during the session. The processor retrieves previous conversation content from a database related to the user profile to provide context and background for the ongoing session. The historical data allows the AI model to understand the user's past interactions and preferences, which is crucial for accurate analysis and prediction.

In some examples and features of the instant solution, the trained AI model, stored in the memory, is executed by the processor. The AI model analyzes the current conversation content along with the historical conversation content and at least one future correspondence. The analysis helps the AI model determine when any part of the future correspondence includes descriptions of objects or information that are no longer relevant or needed by the user. Based on the analysis, the processor identifies specific descriptions of objects within the future correspondence that is to be removed. For instance, when a user has already expressed disinterest in a particular product or service during the ongoing or previous conversations, any mention of that product or service in future correspondences may be deemed unnecessary.

In some examples and features of the instant solution, the processor modifies the future correspondence by deleting the identified descriptions of irrelevant objects generating a refined version of the correspondence that is more relevant to the user's current needs and preferences. The modification process ensures that the user receives only pertinent information, enhancing the overall communication experience and reducing potential confusion or frustration caused by receiving redundant or unwanted information. For example, during an ongoing communication session, the AI model might analyze the user's current inquiries and compare them with previous interactions. Suppose the user had previously inquired about but ultimately decided against a particular credit card offer. In that case, the AI model may recognize this and ensure that future emails or messages do not include promotions for that specific credit card, focusing instead on more relevant products or services. Additionally, the processor adds a model feedback record that includes details of the conversation content, previous conversation content, and the modifications made to future correspondence. The feedback is used to retrain the AI model, continuously improving its accuracy and effectiveness over time.

In some examples and features of the instant solution, the instant solution details the apparatus's capability to train and utilize a second AI model specifically for tone analysis, which influences the dynamic offering of objects during ongoing communication sessions. The apparatus comprises a memory configured to store multiple AI models, including the second AI model dedicated to tone analysis, and a processor designed to perform various functions. The processor trains the second AI model using a neural network training capability. The training involves historical conversation content and the corresponding tones identified in those conversations. The historical data includes transcripts of past interactions and labels indicating the emotional tone (e.g., happy, frustrated, neutral) during different parts of the conversations.

In some examples and features of the instant solution, once the second AI model is trained, it is stored in the memory and ready for deployment during real-time interactions. During an ongoing communication session, the processor receives conversation content from a computing device associated with a user profile. The content can be speech, chat messages, or other forms of interaction captured by the software application running on the user's device. The processor retrieves previous conversation content from a database related to the user profile to provide context. The historical data is crucial for the AI models to make accurate predictions and recommendations based on the user's past interactions and preferences. The second AI model is executed by the processor to analyze the current conversation content and determine the tone of the ongoing communication session. The tone analysis involves processing the real-time speech or text to identify emotional cues and context, allowing the AI model to categorize the conversation's emotional state accurately.

In some examples and features of the instant solution, based on the identified tone, the processor dynamically determines the most appropriate object to offer during the communication session. For instance, when the tone analysis reveals that the user is frustrated, the AI model might decide to offer a solution-oriented product or service that addresses the user's immediate concerns, aiming to improve the user experience and satisfaction. The processor outputs a selectable option to obtain the determined object via the GUI of the software application. The GUI is part of the software application running on the user's computing device, enabling seamless interaction. The selectable option is presented in real time, allowing the user to accept or reject the offer during the ongoing conversation. Additionally, the processor adds a model feedback record that includes details such as the conversation content, the determined tone, the object offered, and whether the selectable option was chosen by the user. This feedback is used to retrain both the primary and the second AI models, continuously enhancing their predictive accuracy and overall effectiveness. For example, during a telephone call, the processor continuously receives and converts the speech to text. The second AI model processes the text to identify the tone of the conversation. When the tone is identified as positive, the AI model might offer a promotional product. Conversely, when the tone is negative, the AI model might offer support services or solutions to address the user's concerns. The software application displays the selectable option on the GUI, enabling the user to interact with the offer without interrupting the conversation.

In some examples and features of the instant solution, the instant solution is configured to dynamically offer objects in real-time based on the tone of the ongoing communication session. The apparatus comprises a memory configured to store multiple AI models, including a model trained to determine the tone of a conversation and a processor designed to execute several key functions. The processor trains the AI model using a neural network training capability. The training involves historical conversation content and corresponding tone data. The historical data includes transcripts of past interactions and labels indicating the emotional tone (e.g., happy, frustrated, neutral) during different parts of these conversations.

In some examples and features of the instant solution, once the tone-detection AI model is trained, it is stored in the memory and ready for deployment during real-time interactions. During an ongoing communication session, the processor receives conversation content from a computing device associated with a user profile. The content can include spoken words, chat messages, or other forms of interaction captured by the software application running on the user's device. The processor retrieves previous conversation content from a database related to the user profile to provide context. The historical data enables the AI models to make accurate predictions and recommendations based on the user's past interactions and preferences.

In some examples and features of the instant solution, the trained tone-detection AI model is executed by the processor to analyze the current conversation content and determine the emotional tone of the ongoing communication session. The analysis involves processing the real-time speech or text to identify emotional cues and context, allowing the AI model to categorize the conversation's emotional state accurately. Based on the identified tone, the processor dynamically determines the most appropriate object to offer during the communication session. For instance, when the tone analysis reveals that the user is frustrated, the AI model might decide to offer a solution-oriented product or service that addresses the user's immediate concerns, aiming to improve the user experience and satisfaction. Conversely, when the tone is positive, the AI model might offer a promotional product or a reward.

In some examples and features of the instant solution, the processor outputs a selectable option to obtain the determined object via the GUI of the software application. The GUI is part of the software application running on the user's computing device, allowing for seamless interaction. The selectable option is presented in real-time, providing the user with an immediate opportunity to accept or reject the offer during the ongoing conversation. Additionally, the processor adds a model feedback record that includes details such as the conversation content, the determined tone, the object offered, and whether the selectable option was chosen by the user. The feedback is used to retrain both the primary AI model and the tone-detection AI model, continuously enhancing their predictive accuracy and overall effectiveness. For example, during a telephone call, the processor continuously receives and converts the speech to text. The tone-detection AI model processes this text to identify the tone of the conversation. When the tone is identified as positive, the AI model might offer a promotional product. Conversely, when the tone is negative, the AI model might offer support services or solutions to address the user's concerns. The software application then displays the selectable option on the GUI, allowing the user to interact with the offer without interrupting the conversation.

In some examples and features of the instant solution, the instant solution is configured to incorporate feedback from interaction sessions to continuously retrain the AI model, thereby improving its predictive accuracy and effectiveness. The apparatus comprises a memory configured to store the AI model and a processor designed to execute various functions. The processor trains the AI model using a neural network training capability. The training process involves using historical conversation logs, identifiers of objects offered during those conversations, the specific times when these objects were offered, and model feedback data. The comprehensive dataset allows the AI model to learn and predict the most relevant objects to offer during future conversations. During an ongoing communication session, the processor receives conversation content from a computing device associated with a user profile. The content can include spoken words, chat messages, or other forms of interaction captured by the software application running on the user's device. The processor retrieves previous conversation content related to the user profile from a database to provide context and background for the ongoing session.

In some examples and features of the instant solution, the trained AI model is executed by the processor to analyze the current conversation content alongside the historical conversation content. The analysis enables the AI model to determine a suitable object to offer to the user during the ongoing communication session. The processor outputs a selectable option to obtain the object via the GUI of the software application. The GUI, part of the software application running on the user's computing device, facilitates seamless interaction, allowing the user to accept or reject the offer during the session. The apparatus includes mechanisms for incorporating user feedback to enhance the AI model. The processor adds a model feedback record that includes details such as the conversation content, the previous conversation content, the object offered, and whether the selectable option was chosen by the user. The feedback is crucial as it provides real-world data on the AI model's performance, indicating how well the model's predictions align with user preferences and actions. The feedback data is used to retrain the AI model continuously. By incorporating the feedback, the AI model adapts to new patterns and trends in user behavior, improving its predictive accuracy over time. For instance, when the AI model offers a product and the user consistently accepts it, the model learns to prioritize similar offers in future interactions. Conversely, when the user consistently rejects certain offers, the model adjusts its predictions to avoid making similar suggestions. For example, during a telephone call, the processor continuously receives and converts the speech to text. The AI model processes this text along with historical data to predict an object of interest. The software application displays the selectable option on the GUI, enabling the user to interact with the offer. After the session, the processor records whether the user accepted or rejected the offer. The information is added to the model feedback record, which is then used to retrain the AI model.

In some examples and features of the instant solution, the instant solution is configured to output a description of an object to a second graphical user interface (GUI) with a visual indicator, ensuring that the selectable option is prominently displayed and easily accessible to the user. The apparatus comprises a memory configured to store the AI model and a processor designed to perform several critical functions. The processor trains the AI model using a neural network training capability. The training process involves utilizing call logs of historical conversations, identifiers of objects offered during those conversations, the specific times when these objects were offered, and model feedback data. The comprehensive dataset allows the AI model to learn and predict the most relevant objects to offer during future conversations.

In some examples and features of the instant solution, during an ongoing communication session, the processor receives conversation content from a computing device associated with a user profile. The content can include spoken words, chat messages, or other forms of interaction captured by the software application running on the user's device. The processor retrieves previous conversation content from a database related to the user profile to provide context and background for the ongoing session. The trained AI model is executed by the processor to analyze the current conversation content alongside the historical conversation content. The analysis enables the AI model to determine a suitable object to offer to the user during the ongoing communication session. Based on the AI model's prediction, the processor prepares a description of the identified object. The processor outputs a selectable option to obtain the determined object via the GUI of the software application. The UI is part of the software application running on the user's computing device. To ensure that the user is aware of the offer and can easily interact with it, the processor also outputs a description of the object to a second GUI, which may be part of the same software application or a different one. The second GUI includes a visual indicator that highlights the selectable option, making it prominent and easily accessible. For instance, when the user is engaged in a telephone call via a software application, the processor converts the speech to text and uses the AI model to analyze the content. The AI model determines an object of interest, and the processor prepares a description of this object. The software application then displays the selectable option on the primary GUI with an interactive element, such as a button, that the user can click to accept the offer. Simultaneously, the second GUI, which might be displayed on another screen or as a pop-up, shows the description of the object with a visual indicator, ensuring that the user notices the offer. Additionally, the processor includes mechanisms for incorporating user feedback to enhance the AI model. The processor adds a model feedback record that includes details such as the conversation content, the object offered, and whether the selectable option was chosen by the user. For example, during an ongoing communication session, the processor continuously receives and processes the conversation content. The AI model identifies a relevant object, and the processor ensures that the offer is displayed prominently on both the primary and secondary GUIs. The user's interaction with these GUIs is recorded as feedback, which is then used to refine the AI model's future predictions.

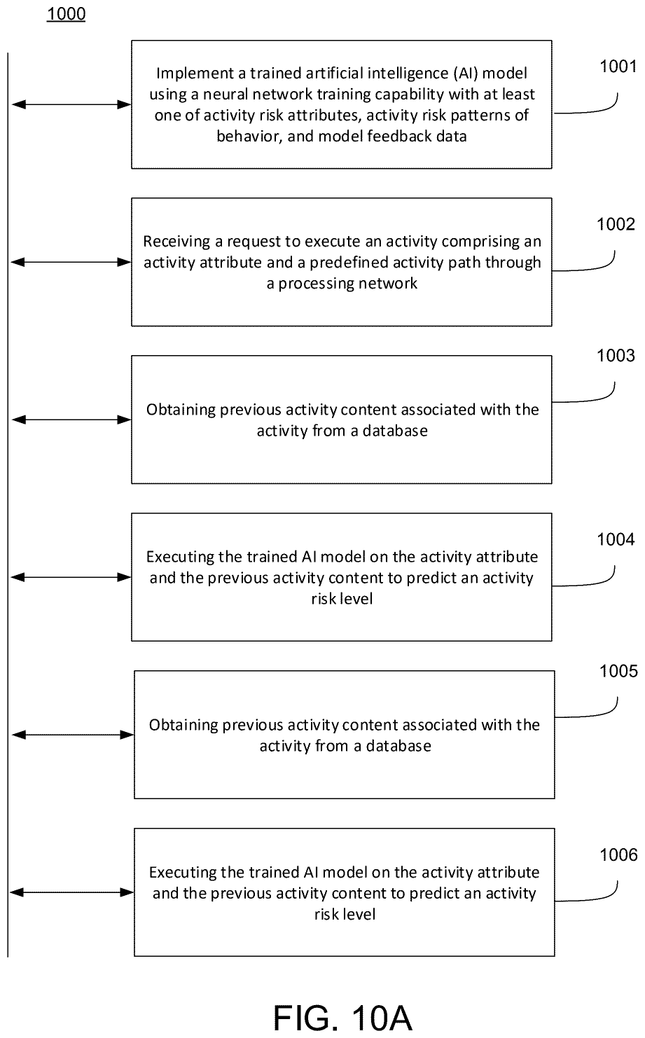

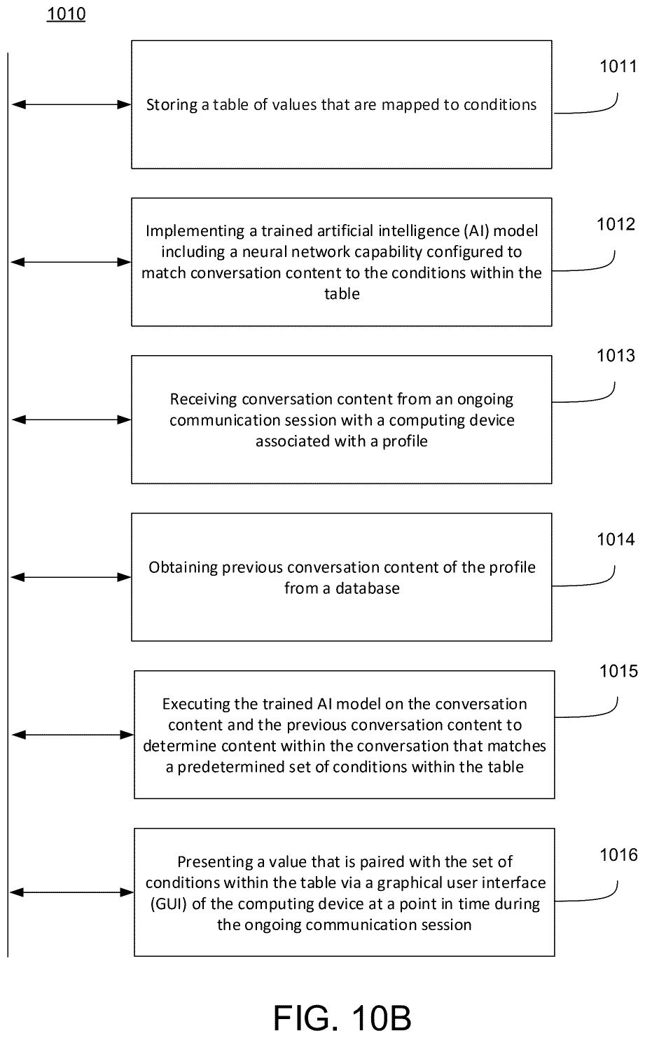

FIG. 10A illustrates a method 1000 of generating a different transaction based on a fraud indicator according to examples and features of the instant solution. For example, the method 1000 may be performed by a host platform such as a cloud platform, a web server, a software application, a combination of systems, and the like. Referring to FIG. 10A, in 1001, the method may include implement a trained artificial intelligence (AI) model using a neural network training capability with at least one of activity risk attributes, activity risk patterns of behavior, and model feedback data. In 1002, the method may include receiving a request to execute an activity comprising an activity attribute and a predefined activity path through a processing network. In 1003, the method may include obtaining previous activity content associated with the activity from a database. In 1004, the method may include executing the trained AI model on the activity attribute and the previous activity content to predict an activity risk level. In 1005, the method may include generating a different activity which includes a lesser activity attribute than the activity attribute of the activity based on the activity risk level. In 1006, the method may include outputting an authorization request message to confirm the different activity on a graphical user interface (GUI) of a computing device.

In some examples and features of the instant solution, the generating the different transaction may include simultaneously preventing the transaction from being executed, generating a queue entry corresponding to the transaction, marking the queue entry with an identifier of the different transaction, and adding the queue entry to a storage queue. In some examples and features of the instant solution, the generating the different transaction may include determining a different processing path for the different transaction through a processing network based on the fraud indicator and marking a field of an authorization request message of the different transaction with an identifier of the different processing path.

In some examples and features of the instant solution, the determining the different processing path for the different transaction may include identifying an additional processing node for processing the different transaction based on a processing model of the processing network. In some examples and features of the instant solution, the method may further include determining that the different transaction is successfully executed, and in response, determining a remainder of the transaction attribute based on the lesser transaction attribute and executing a second transaction for the remainder of the transaction attribute after a predetermined period of time from when the different transaction is successfully executed.

In some examples and features of the instant solution, the method may further include determining whether the different transaction includes fraud, adding a model feedback record which includes the transaction, the different transaction, and an indication of whether the different transaction includes fraud, to the model feedback data, and retraining the trained AI model with the model feedback data including the model feedback record. In some examples and features of the instant solution, the outputting may include outputting a description of the different transaction with a visual indicator which indicates the transaction is being limited to the different transaction via the GUI.

FIG. 10B illustrates a method 1010 of dynamically offering an object during a communication session according to examples and features of the instant solution. For example, the method 1010 may be performed by a host platform such as a cloud platform, a web server, a software application, a combination of systems, and the like. Referring to FIG. 10B, in 1011, the method may include storing a table of values that are mapped to conditions. In 1012, the method may include implementing a trained artificial intelligence (AI) model including a neural network capability configured to match conversation content to the conditions within the table. In 1013, the method may include receiving conversation content from an ongoing communication session with a computing device associated with a profile.

In 1014, the method may include obtaining previous conversation content of the profile from a database. In 1015, the method may include executing the trained AI model on the conversation content and the previous conversation content to determine content within the conversation that matches a predetermined set of conditions within the table. In 1016, the method may include presenting a value that is paired with the set of conditions within the table via a graphical user interface (GUI) of the computing device at a point in time during the ongoing communication session.

In some embodiments, the ongoing communication session may include a telephone call conducted via a software application, the receiving comprises receiving speech from the telephone call that is converted to text, and the outputting comprises outputting the selectable option during the telephone call via the software application. In some embodiments, the method may further include executing the trained AI model on the conversation content, previous conversation content, and at least one future correspondence, to determine unwanted content to be removed from the at least one future correspondence, and in response, deleting the unwanted content from the at least one future correspondence to generate a modified at least one future correspondence.

In some embodiments, the method may further include implementing a second trained AI model configured to determine a tone of a conversation, and executing the trained second AI model on the conversation content to determine a current tone of the ongoing communication session. In some embodiments, the method may further include determining to output the value based on the current tone of the ongoing communication session. In some embodiments, the method may further include generating a model feedback record which includes at least one of the conversation content, previous conversation content, an identifier of the value, and an indication of whether the value was accepted, and retraining the trained AI model based on the model feedback record. In some embodiments, the outputting may include outputting a description of the value to a second graphical user interface (GUI) with a visual indicator which indicates the value is being output via the GUI.

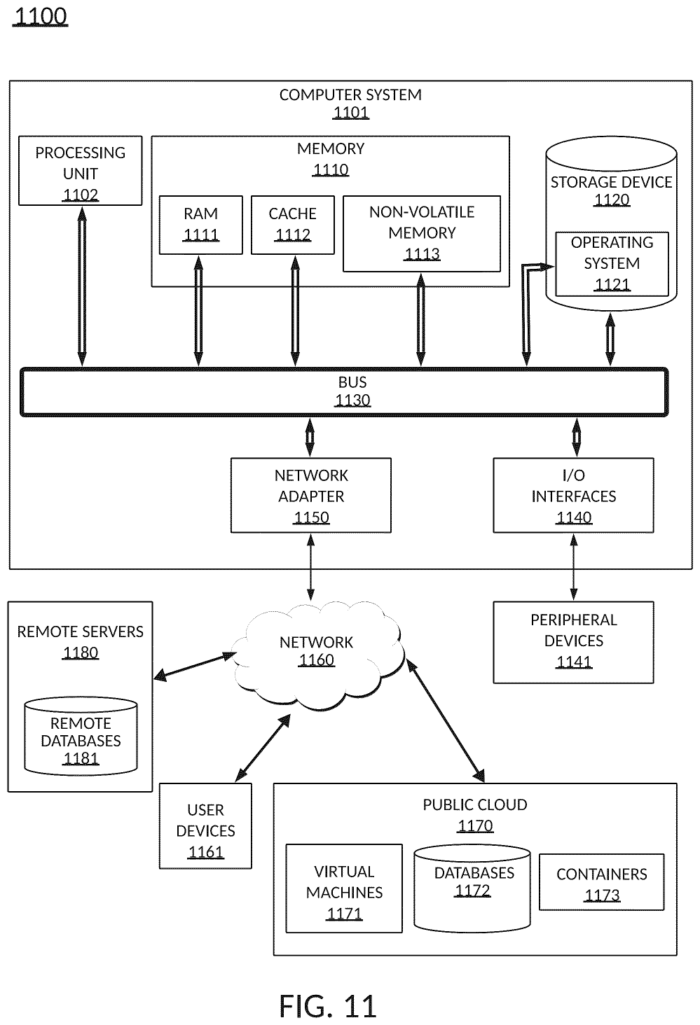

The examples and features of the instant solution may be implemented in one or more of the elements described or depicted herein, including for example, the elements described or depicted in FIG. 11. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 11 illustrates an example computer system architecture, which may represent or be integrated in any of the above-described components, etc.

FIG. 11 illustrates a computing environment according to the instant solution's example features, structures, or characteristics. FIG. 11 is not intended to suggest any limitation as to the scope of use or functionality of features, structures, or characteristics of the instant solution of the application described herein. Regardless, the computing environment 1100 can be implemented to perform any of the functionalities described herein. In computing environment 1100, there is a computer system 1101, operational within numerous other general-purpose or special-purpose computing system environments or configurations.

Computer system 1101 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 1160 or querying a database. Depending upon the technology, the performance of a computer-implemented method may be distributed among multiple computers and among multiple locations. However, in this presentation of the computing environment 1100, a detailed discussion is focused on a single computer, specifically computer system 1101, to keep the presentation as simple as possible.

Computer system 1101 may be located in a cloud, even though it is not shown in a cloud in FIG. 11. On the other hand, computer system 1101 may not be in a cloud except to any extent as may be affirmatively indicated. Computer system 1101 may be described in the general context of computer system-executable instructions, such as program modules, executed by a computer system 1101. Generally, program modules may include routines, programs, objects, components, logic, data structures, and so on that perform tasks or implement certain abstract data types. As shown in FIG. 11, computer system 1101 in computing environment 1100 is shown in the form of a general-purpose computing device. The components of computer system 1101 may include but are not limited to, at least one processor or processing unit 1102, a system memory 1110, and a bus 1130 that couples various system components, including system memory 1110 to processing unit 1102.

Processing unit 1102 includes at least one computer processor of any type now known or to be developed. The processing unit 1102 may contain circuitry distributed over multiple integrated circuit chips. The processing unit 1102 may also implement multiple processor threads and multiple processor cores. Cache 1112 is a memory that may be in the processor chip package(s) or located “off-chip,” as depicted in FIG. 11. Cache 1112 is typically used for data or code accessed by the threads or cores running on the processing unit 1102. In some computing environments, processing unit 1102 may be designed to work with qubits and perform quantum computing.

Memory 1110 is any volatile memory now known or to be developed in the future. Examples include dynamic random-access memory (RAM) 1111 or static type RAM 1111. Typically, the volatile memory is characterized by random access, but this may not be the characterization unless affirmatively indicated. In computer system 1101, memory 1110 is in a single package. It is internal to computer system 1101, but alternatively or additionally, the volatile memory may be distributed over multiple packages and/or located externally with respect to computer system 1101. By way of example, memory 1110 can be provided for reading from and writing to a non-removable, non-volatile magnetic media (shown as storage device 1120, and typically called a “hard drive”). Memory 1110 may include at least one program product having a set (e.g., at least one) of program modules configured to carry out the functions of various features, structures, or characteristics of the instant solution of the application. A typical computer system 1101 may include cache 1112, a specialized volatile memory generally faster than RAM 1111 and generally located closer to the processing unit 1102. Cache 1112 stores frequently accessed data and instructions accessed by the processing unit 1102 to speed up processing time. The computer system 1101 may also include non-volatile memory 1113 in the form of ROM, PROM, EEPROM, and flash memory. Non-volatile memory 1113 often contains programming instructions for starting the computer, including the basic input/output system (BIOS) and information to start the operating system 1121.

Computer system 1101 may include a removable/non-removable, volatile/non-volatile computer storage device 1120. For example, storage device 1120 can be a non-removable, non-volatile magnetic media (not shown and typically called a “hard drive”). At least one data interface can connect it to the bus 1130. In features, structures, or characteristics of the instant solution where computer system 1101 has a large amount of storage (for example, where computer system 1101 locally stores and manages a large database), then this storage may be provided by peripheral storage devices 1120 designed for storing very large amounts of data, such as a storage area network (SAN) that is shared by multiple, geographically distributed computers.

The operating system 1121 is software that manages computer system 1101 hardware resources and provides common services for computer programs. Operating system 1121 may take several forms, such as various known proprietary operating systems or open-source Portable Operating System Interface type operating systems that employ a kernel.

The bus 1130 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 1130 is the signal conduction path that allows the various components of computer system 1101 to communicate.

Computer system 1101 may communicate with at least one peripheral device, 1141, via an input/output (I/O) interface, 1140. Such devices may include a keyboard, a pointing device, a display, etc.; at least one device that enables a user to interact with computer system 1101; and/or any devices (e.g., network card, modem, etc.) that enable computer system 1101 to communicate with at least one other computing devices. Such communication can occur via I/O interface 1140. As depicted, I/O interface 1140 communicates with the other components of computer system 1101 via bus 1130.

Network adapter 1150 enables the computer system 1101 to connect and communicate with at least one network 1160, such as a local area network (LAN), a wide area network (WAN), and/or a public network (e.g., the Internet). It bridges the computer's internal bus 1130 and the external network, exchanging data efficiently and reliably. The network adapter 1150 may include hardware, such as modems or Wi-Fi signal transceivers, and software for packetizing and/or de-packetizing data for communication network transmission. Network adapter 1150 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 1160 is any computer network that can receive and/or transmit data. Network 1160 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 1160 may be replaced and/or supplemented by LANs designed to communicate data between devices in a local area, such as a Wi-Fi network. The network 1160 typically includes computer hardware such as copper transmission cables, optical transmission fibers, wireless transmission, routers, firewalls, switches, gateway computers, edge servers, and network infrastructure known now or to be developed in the future. Computer system 1101 connects to network 1160 via network adapter 1150 and bus 1130.

User devices 1161 are any computer systems used and controlled by an end user in connection with computer system 1101. For example, in a hypothetical case where computer system 1101 is designed to provide a recommendation to an end user, this recommendation may typically be communicated from network adapter 1150 of computer system 1101 through network 1160 to a user device 1161, allowing user device 1161 to display, or otherwise present, the recommendation to an end user. User devices can be a wide array, including personal computers, laptops, tablets, hand-held, mobile phones, etc.

A public cloud 1170 is an on-demand availability of computer system resources, including data storage and computing power, without direct active management by the user. Public clouds 1170 are often distributed, with data centers in multiple locations for availability and performance. Computing resources on public clouds 1170 are shared across multiple tenants through virtual computing environments comprising virtual machines 1171, databases 1172, containers 1173, and other resources. A container 1173 is an isolated, lightweight software for running a software application on the host operating system 1121. Containers 1173 are built on top of the host operating system's kernel and contain software applications and some lightweight operating system APIs and services. In contrast, virtual machine 1171 is a software layer with an operating system 1121 and kernel. Virtual machines 1171 are built on top of a hypervisor emulation layer designed to abstract a host computer's hardware from the operating software environment. Public clouds 1170 generally offers databases 1172, abstracting high-level database management activities. At least one element described or depicted in FIG. 11 can perform at least one of the actions, functionalities, or features described or depicted herein.

Remote servers 1180 are any computers that serve at least some data and/or functionality over a network 1160, for example, WAN, a virtual private network (VPN), a private cloud, or via the Internet to computer system 1101. These networks 1160 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 1180 can also host remote databases 1181, with the database located on one remote server 1180 or distributed across multiple remote servers 1180. Remote databases 1181 are accessible from database client applications installed locally on the remote server 1180, other remote servers 1180, user devices 1161, or computer system 1101 across a network 1160. An AI/ML model described or depicted here may reside fully or partially on any of the elements described or depicted in FIG. 11.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

What is claimed is:

1. An apparatus, comprising:
a memory; and
a processor coupled to the memory and configured to:
implement a trained artificial intelligence (AI) model through a use of a neural network training capability with at least one of activity risk attributes, activity risk patterns of behavior, and model feedback data,
receive a request to execute an event comprising a first event attribute and a predefined event path through a processing network,
obtain previous event content associated with the event from a database,
execute an AI model on the first event attribute and the previous event content to predict an event risk level,
generate a different event which includes a second event attribute than the first event attribute of the event based on the event risk level, and
output a default automated action of the different event.

2. The apparatus of claim 1, wherein the processor is configured to simultaneously prevent the event from that is executed, generate a queue entry that corresponds to the event, mark the queue entry with an identifier of the different event, and add the queue entry to a storage queue.

3. The apparatus of claim 1, wherein the processor is configured to:
determine a different processing path for the different event through the processing network based on the event risk level, and mark a field of an authorization request message of the different event with an identifier of the different processing path; and
output the authorization request message to confirm the different event on a graphical user interface (GUI) of a computing device.

4. The apparatus of claim 3, wherein the processor is configured to identify an additional processing node for processing the different event based on a processing model of the processing network.

5. The apparatus of claim 1, wherein the processor is configured to determine that the different event is successfully executed, and in response, determine a remainder of the first event attribute based on the second event attribute and execute another event for the remainder of the first event attribute after a predetermined period of time from when the different event is successfully executed.

6. The apparatus of claim 1, wherein the processor is configured to determine whether the different event includes activity risk, add a model feedback record which includes the event, the different event, and an indication of whether the different event includes activity risk, to the model feedback data, and retrain the trained AI model with the model feedback data that includes the model feedback record.

7. The apparatus of claim 1, wherein the processor is configured to output a description of the different event with a visual indicator which indicates the event is being limited to the different event via a graphical user interface (GUI) of a computing device.

8. A method, comprising:
implementing a trained artificial intelligence (AI) model using a neural network training capability with at least one of activity risk attributes, activity risk patterns of behavior, and model feedback data;
receiving a request to execute an event comprising a first event attribute and a predefined event path through a processing network;
obtaining previous event content associated with the event from a database;
executing an AI model on the first event attribute and the previous event content to predict an event risk level;
generating a different event which includes a second event attribute than the first event attribute of the event based on the event risk level; and
outputting a default automated action of the different event.

9. The method of claim 8, wherein the generating the different event comprises simultaneously preventing the event from being executed, generating a queue entry corresponding to the event, marking the queue entry with an identifier of the different event, and adding the queue entry to a storage queue.

10. The method of claim 8, wherein the generating the different event comprises determining a different processing path for the different event through the processing network based on the activity risk level, and marking a field of the authorization request message of the different event with an identifier of the different processing path; and
outputting the authorization request message to confirm the different event on a graphical user interface (GUI) of a computing device.

11. The method of claim 10, wherein the determining the different processing path for the different event comprises identifying an additional processing node for processing the different event based on a processing model of the processing network.

12. The method of claim 8, comprising determining that the different event is successfully executed, and in response, determining a remainder of the first event attribute based on the second event attribute and execute another event for the remainder of the first event attribute after a predetermined period of time from when the different event is successfully executed.

13. The method of claim 8, comprising:
determining whether the different event includes activity risk, add a model feedback record which includes the event, the different event, and an indication of whether the different event includes activity risk, to the model feedback data; and
retraining the trained AI model with the model feedback data including the model feedback record.

14. The method of claim 8, comprising outputting a description of the different event with a visual indicator which indicates the event is being limited to the different event via a graphical user interface (GUI) of a computing device.

15. A computer-readable storage medium comprising instructions when executed by a computer cause a processor to perform:
implementing a trained artificial intelligence (AI) model using a neural network training capability with at least one of activity risk attributes, activity risk patterns of behavior, and model feedback data;
receiving a request to execute an event comprising a first event attribute and a predefined event path through a processing network;
obtaining previous event content associated with the event from a database;
executing an AI model on the first event attribute and the previous event content to predict an event risk level;
generating a different event which includes a second event attribute than the first event attribute of the event based on the event risk level; and
outputting a default automated action of the different event.

16. The computer-readable storage medium of claim 15, wherein the generating the different event comprises simultaneously preventing the event from being executed, generating a queue entry corresponding to the event, marking the queue entry with an identifier of the different event, and adding the queue entry to a storage queue.

17. The computer-readable storage medium of claim 15, wherein the generating the different event comprises determining a different processing path for the different event through the processing network based on the activity risk level, and marking a field of the authorization request message of the different event with an identifier of the different processing path; and
outputting the authorization request message to confirm the different event on a graphical user interface (GUI) of a computing device.

18. The computer-readable storage medium of claim 17, wherein the determining the different processing path for the different event comprises identifying an additional processing node for processing the different event based on a processing model of the processing network.

19. The computer-readable storage medium of claim 15, wherein the processor is configured to perform determining that the different event is successfully executed, and in response, determining a remainder of the first event attribute based on the second event attribute and execute another event for the remainder of the first event attribute after a predetermined period of time from when the different event is successfully executed.

20. The computer-readable storage medium of claim 15, wherein the processor is configured to perform:
determining whether the different event includes activity risk, add a model feedback record which includes the event, the different event, and an indication of whether the different event includes activity risk, to the model feedback data; and
retraining the trained AI model with the model feedback data including the model feedback record.
